(19) United States
(12) Patent Application Publication
(10) Pub. No.: US 2014/0229390 A1
(43) Pub. Date: Aug. 14, 2014

(54) METHOD AND SYSTEM FOR EVENT PLANNING

(71) Applicants: Stephen Abraham Morris, Los Angeles, CA (US); Bei Yang, Pasadena, CA (US)

(72) Inventors: Stephen Abraham Morris, Los Angeles, CA (US); Bei Yang, Pasadena, CA (US)

(21) Appl. No.: 14/179,016

(22) Filed: Feb. 12, 2014

Related U.S. Application Data
(60) Provisional application No. 61/763,860, filed on Feb. 12, 2013.

(51) Int. Cl. G06Q 10/10; G06F 17/22

(52) U.S. Cl. CPC G06Q 10/103; G06F 17/2247
USPC 705/302

(57) ABSTRACT

A system for providing users with wedding planning tools via a network, comprising one or more servers for executing an application that provides code to a user's client computer for display on the user's client computer of various web pages for planning an event. The web pages comprising a signup page configured to allow the user to sign up to gain access to the system, a plurality of design pages configured to allow the user to design a plurality of different items relating to the event including at least an invitation to the event, and a plurality of layout pages configured to allow the user to plan the arrangement of tables at the event and assign seating for a plurality of guests that are anticipated to attend the event.

This application claims the benefit of U.S. Provisional Patent Application No. 61/763,860 filed on Feb. 12, 2013, which is hereby incorporated by reference in its entirety as if set forth herein.

### BACKGROUND OF THE INVENTION

1. Field of the Invention

The invention relates generally to the field of event planning. In particular, the invention relates to a method and system for planning a social event such as a wedding or meeting.

2. Description of Related Art

Planning a large social event like a wedding or meeting involves a tremendous amount of research, design, and organization. Rather than undertaking the task directly, many people elect to employ expensive event planners. However, the vast majority of social events are planned by the organizers themselves. Prior art methods for event planning include manual planning and software designed to assist with organization. However, the prior art has failed to provide a comprehensive suite of event planning tools that help organizers plan and manage arrangements for a social event.

### SUMMARY OF THE INVENTION

As system for providing users with wedding planning tools via a network, comprising one or more servers for executing an application that provides code to a user's client computer for display on the user's client computer of various web pages for planning an event, the web pages comprising a signup page configured to allow the user to sign up to gain access to the system, a plurality of design pages configured to allow the user to design a plurality of different items relating to the event including at least an invitation to the event, and a plurality of layout pages configured to allow the user to plan the arrangement of tables at the event and assign seating for a plurality of guests that are anticipated to attend the event, wherein information regarding the plurality of guests is obtained in part from a social network selected by the user.

### BRIEF DESCRIPTION OF THE DRAWINGS

FIG. 1 is an illustration of an exemplary sign up page in accordance with the invention.

FIG. 2 is an illustration of an exemplary interview page in accordance with the invention.

FIG. 3 is an illustration of an exemplary interview page in accordance with the invention.

FIG. 4 is an illustration of an exemplary interview page in accordance with the invention.

FIG. 5 is an illustration of an exemplary interview page in accordance with the invention.

FIG. 6 is an illustration of an exemplary design page in accordance with the invention.

FIG. 7 is an illustration of an exemplary design page in accordance with the invention.

FIG. 8 is an illustration of an exemplary design page in accordance with the invention.

FIG. 9 is an illustration of an exemplary design page in accordance with the invention.

FIG. 10 is an illustration of an exemplary design page in accordance with the invention.

FIG. 11 is an illustration of an exemplary design page in accordance with the invention.

FIG. 12 is an illustration of an exemplary design page in accordance with the invention.

FIG. 13 is an illustration of an exemplary design page in accordance with the invention.

FIG. 14 is an illustration of an exemplary design page in accordance with the invention.

FIG. 15 is an illustration of an exemplary design page in accordance with the invention.

FIG.16 is an illustration of an exemplary design page in accordance with the invention.

FIG. 17 is an illustration of an exemplary design page in accordance with the invention.

FIG. 18 is an illustration of an exemplary design page in accordance with the invention.

FIG. 19 is an illustration of an exemplary guest list page in accordance with the invention.

FIG. 20 is an illustration of an exemplary guest list page in accordance with the invention.

FIG. 21 is an illustration of an exemplary guest list page in accordance with the invention.

FIG. 22 is an illustration of an exemplary layout page in accordance with the invention.

FIG. 23 is an illustration of an exemplary layout page in accordance with the invention.

FIG. 24 is an illustration of an exemplary layout page in accordance with the invention.

FIG. 25 is an illustration of an exemplary layout page in accordance with the invention.

FIG. 26 is an illustration of an exemplary planning page in accordance with the invention.

FIG. 27 is an illustration of an exemplary planning page in accordance with the invention.

FIG. 28 is an illustration of an exemplary service provider page in accordance with the invention.

FIG. 29 is an illustration of an exemplary service provider page in accordance with the invention.

FIG. 30 is an illustration of an exemplary service provider page in accordance with the invention.

FIG. 31 is an illustration of an exemplary service provider page in accordance with the invention.

FIG. 32 is an illustration of an exemplary flow chart of steps in accordance with the invention.

FIG. 33 is an illustration of an exemplary flow chart of steps in accordance with the invention.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein

In various exemplary embodiments, the method and system of the present invention is a comprehensive suite of event planning tools designed to help event organizers through the planning process by interviewing and guiding them through an interactive experience. In various exemplary embodiments, the system may filter available service providers and other vendors based on responses from the organizer to provide a manageable set of appealing, targeted options.

The methods and systems disclosed here are designed to help event organizers select and maintain a consistent theme, style, and experience for their event. The system can be integrated with social media sites such as FACEBOOK and GOOGLE+ to simplify the process by importing data such as friends lists for generating a guest list and RSVPs, generating information about relationships such as “+1's” based on social media relationships, and generating seating charts based on relationships such as shared acquaintances.

In various exemplary embodiments, the method and system for event planning may include an online or networked application or platform comprising one or more modules, including without limitation:

1—Comprehensive Interview Module

2—Design Module

3—Hierarchical subvendor analysis module

4—Social Media Integration RSVP Module

5—Seating Chart & Floor Plan Module

6—Layout Module

7—Wedding Service Provider Module

Those skilled in the art will understand that the names given to these modules are exemplary only, and that the same or similar functions and steps can be performed as part of a single unitary system or a modular system. The present invention is not limited to methods and systems having this modular structure.

### Comprehensive Interview Module

In various exemplary embodiments, a comprehensive interview module presents the user with a wide variety of questions designed to elicit key information and preferences from the user about their event. Organizers are asked questions ranging from the names of the hosts, organizers, groom/bride, etc., to dates, locations, religious/cultural affiliation, wedding service preference, estimated number of attendees, estimated budget, formality, food type, and others. Each question may be coupled with a preference indicator that permits the user to identify the relative importance of that factor. For example, a preference indicator such as a slider or dial may be used to indicate that the location and budget are very important to the user, but the desired month is not.

In an exemplary application of the invention for use in planning a wedding, a couple may indicate they want a secular wedding in New York in August for fifty people, their budget is $50,000, with a highly formal presentation, Italian food, and live music. Based on those preferences, the system may present to the user a custom list of wedding service providers located in New York by category, a list of ceremony sites that does not include any churches, synagogues, or other religious sites, reception venues that can accommodate at least fifty people, and live musicians for entertainment. Wedding service providers may be displayed according to the user's preference selections, such that inexpensive options are displayed first for user's selecting a high preference for the budget or caterers specializing in Italian food if food type is ranked high on the preference indicator.

In various exemplary embodiments, information received from other modules will be used to further refine or present information to the user. For example, the service provider module may provide information regarding availability so that only providers with availability for the selected date(s) are presented to the user.

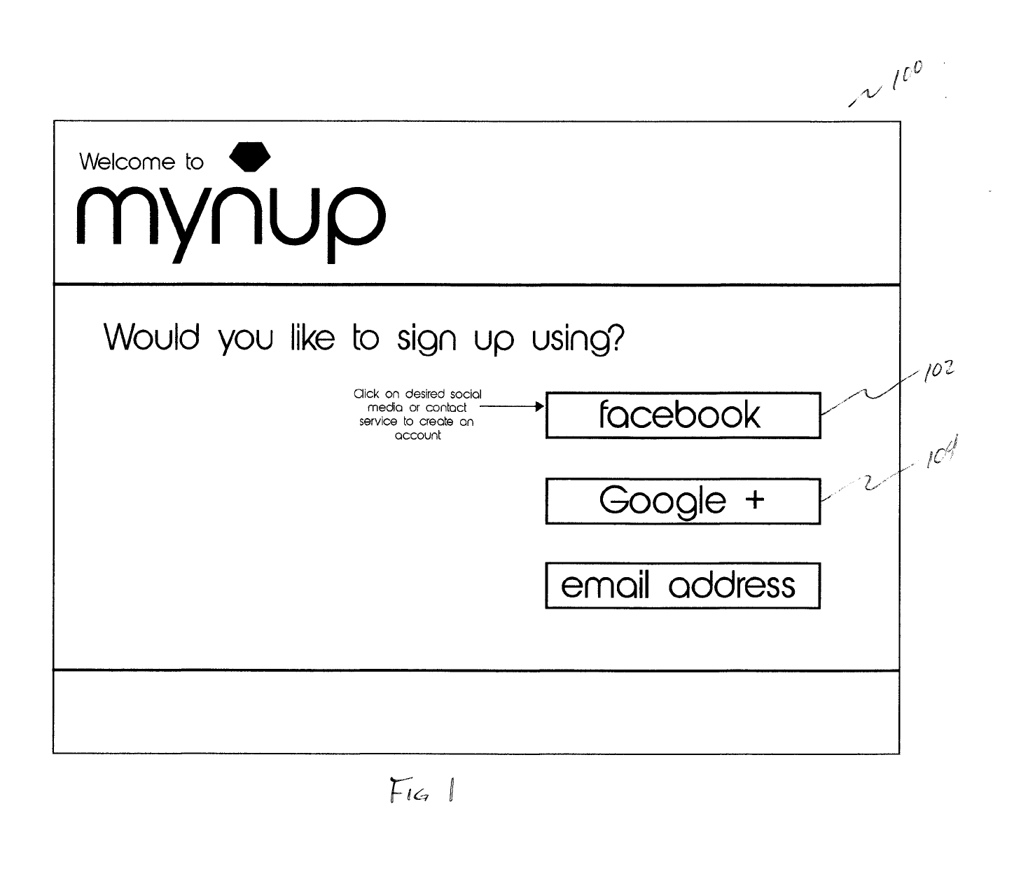

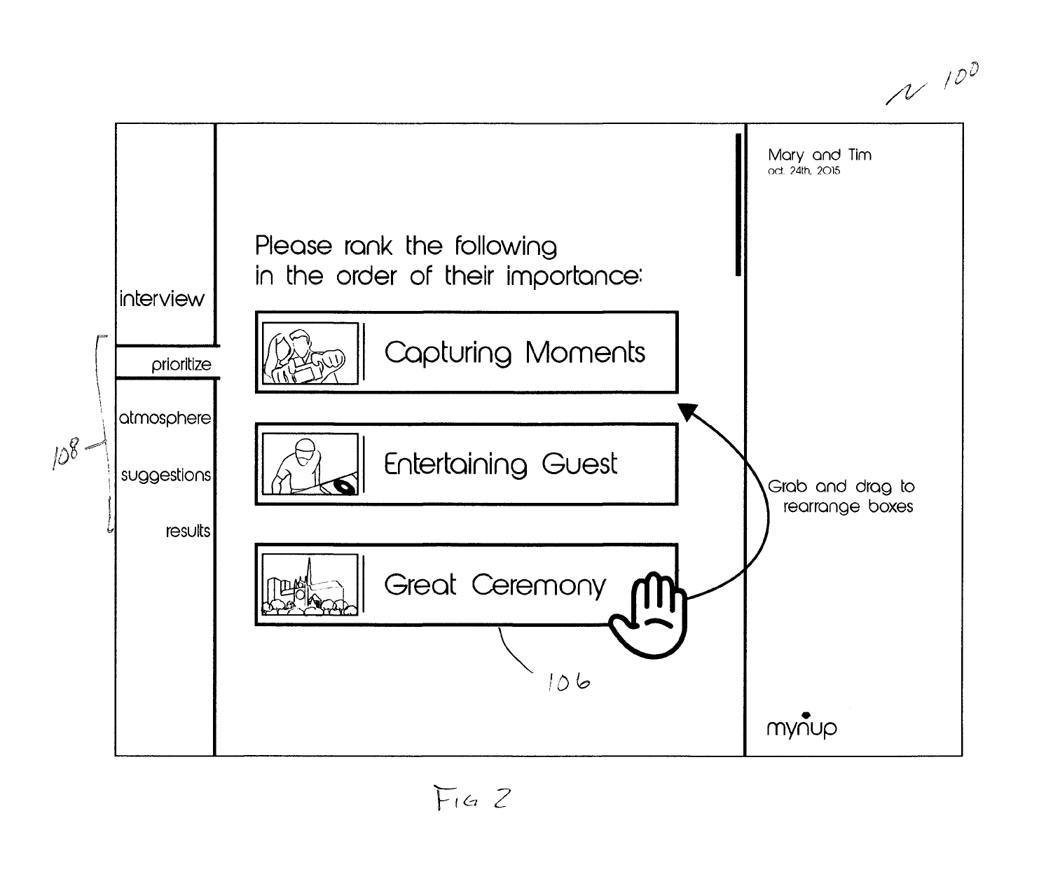

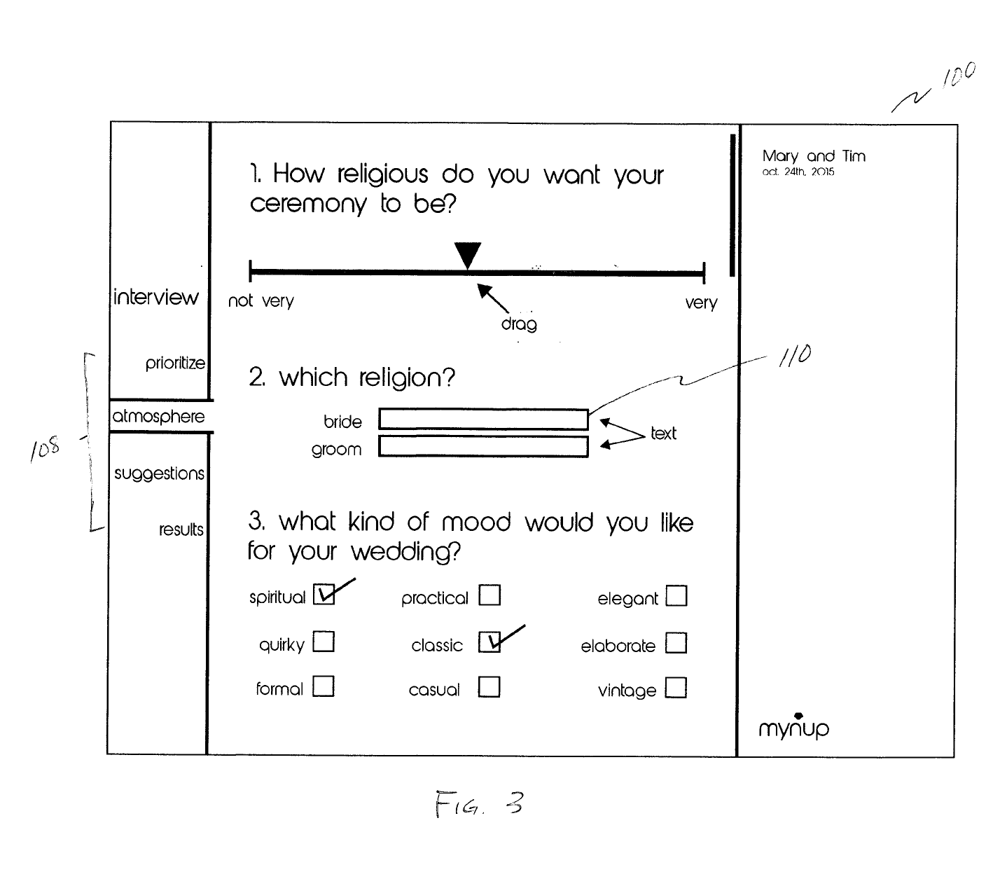

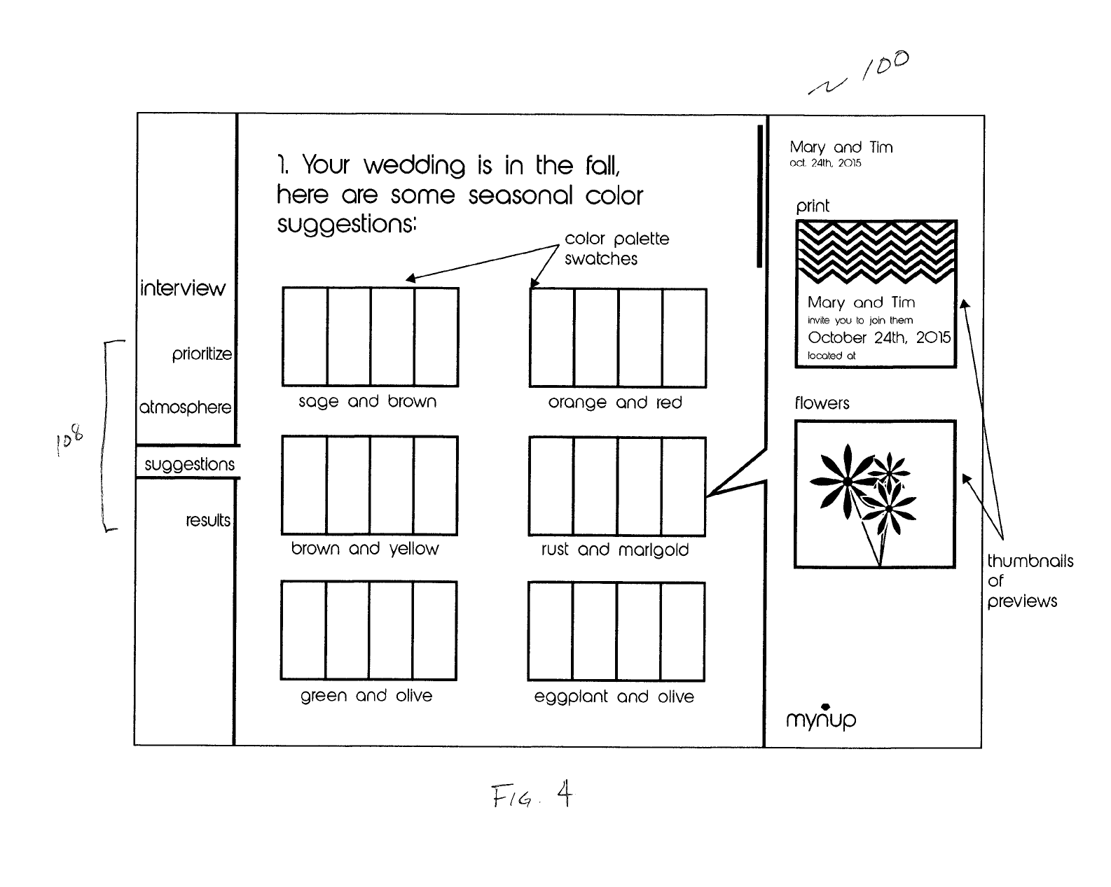

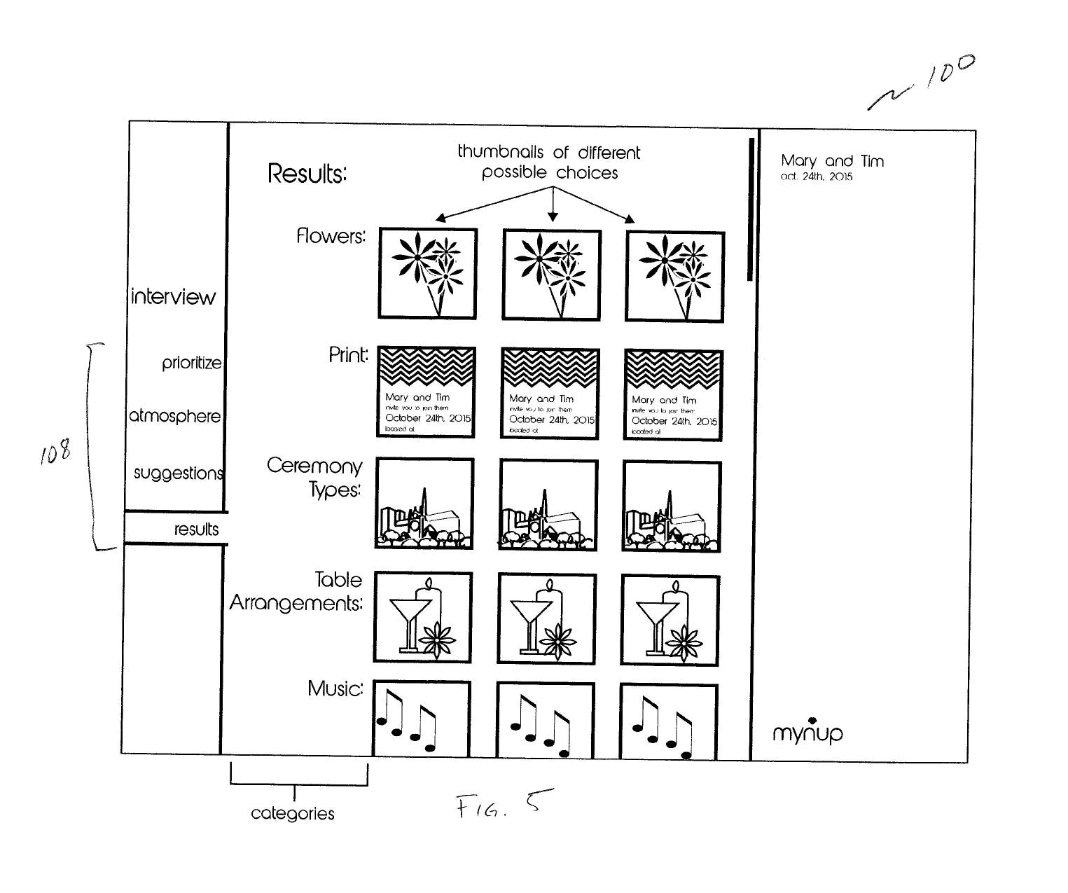

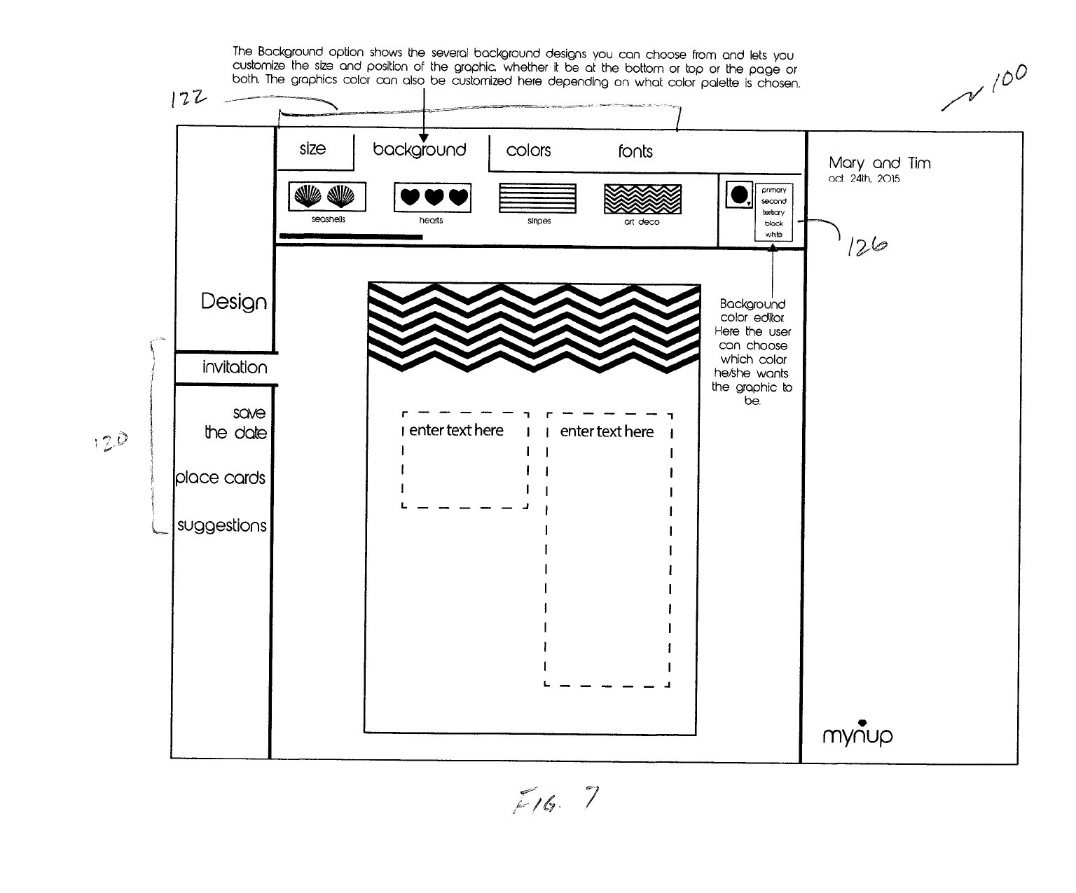

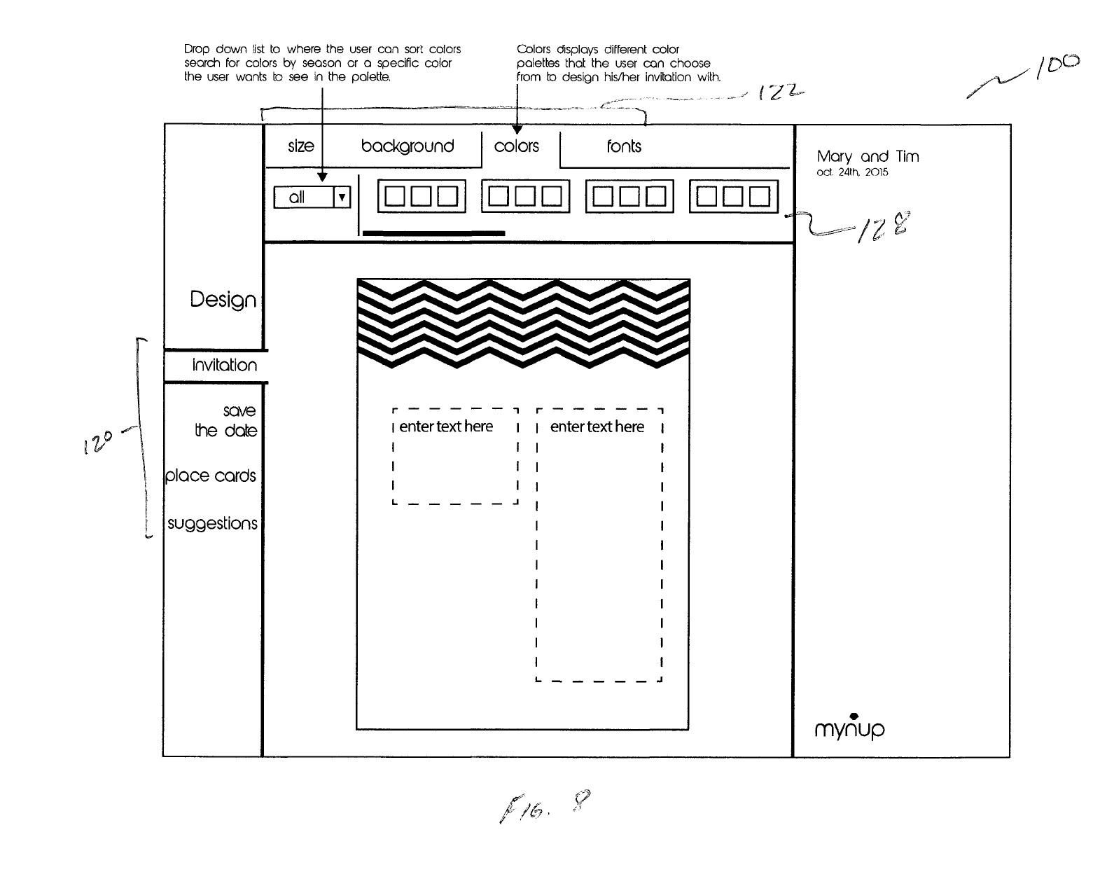

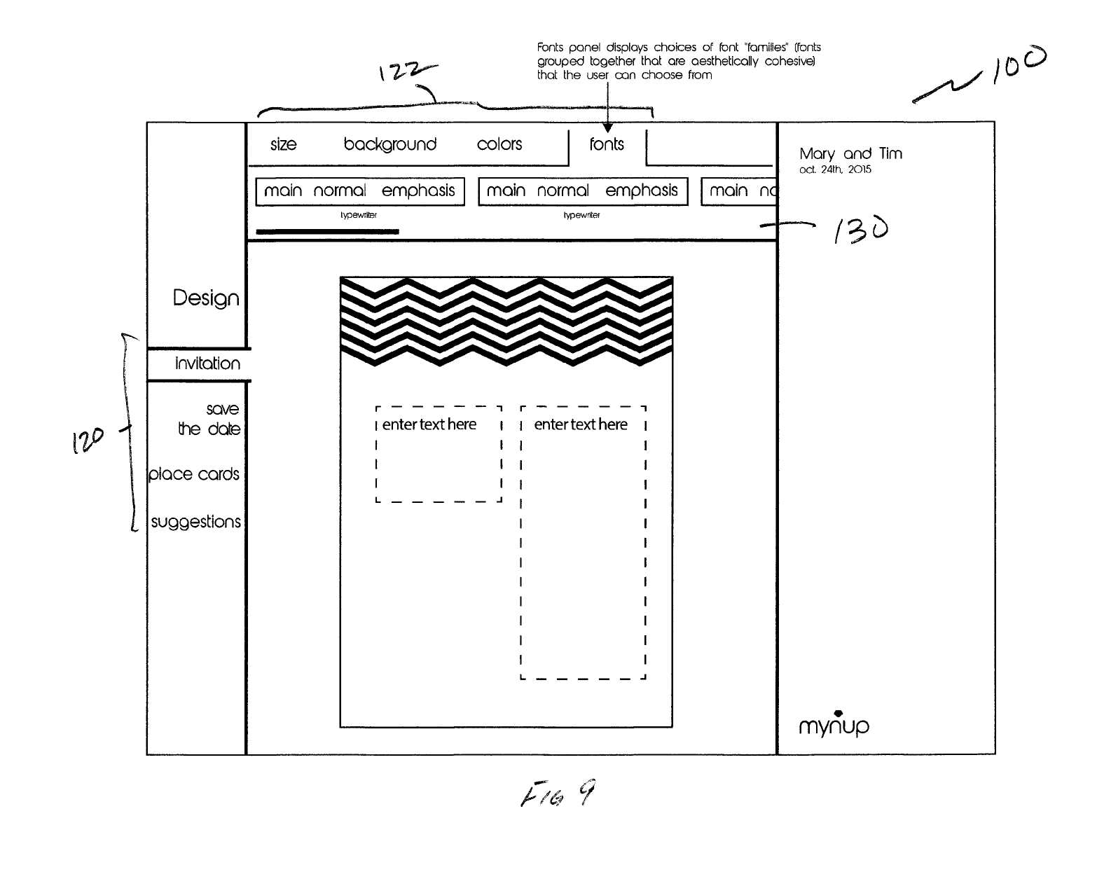

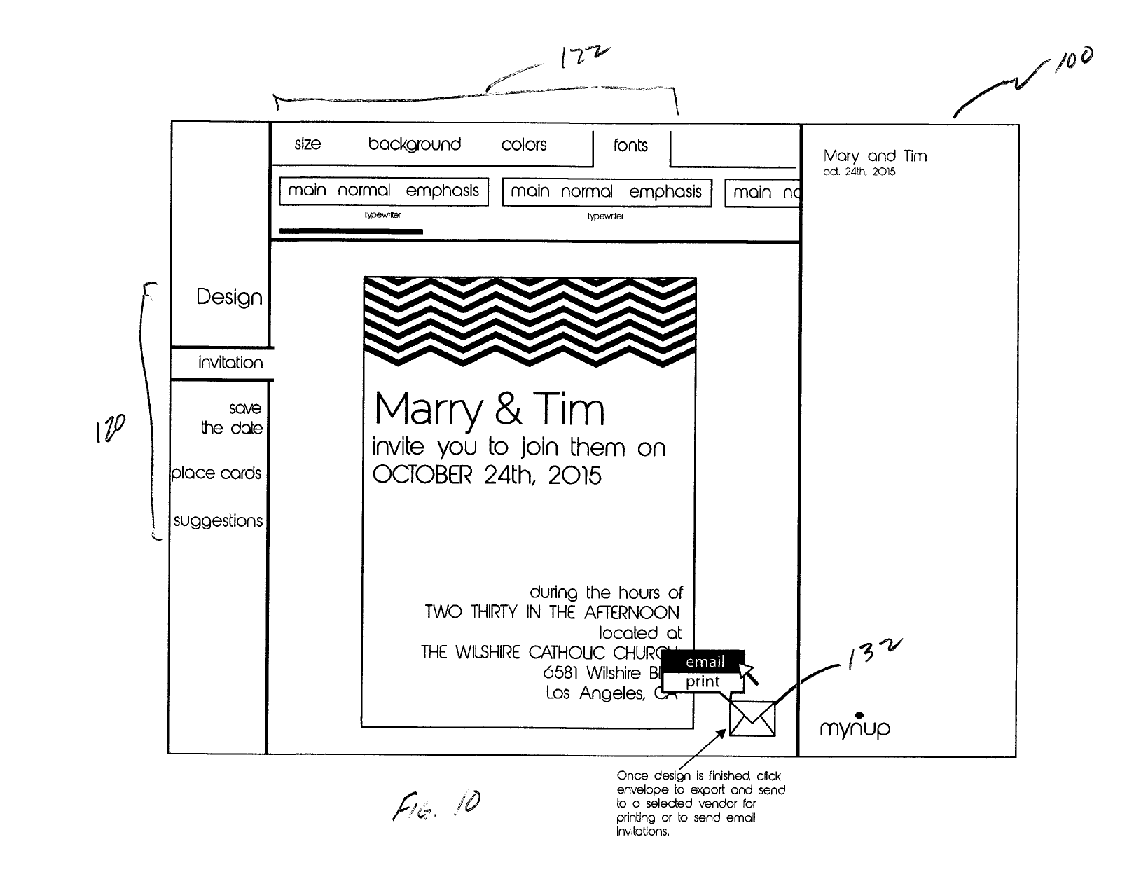

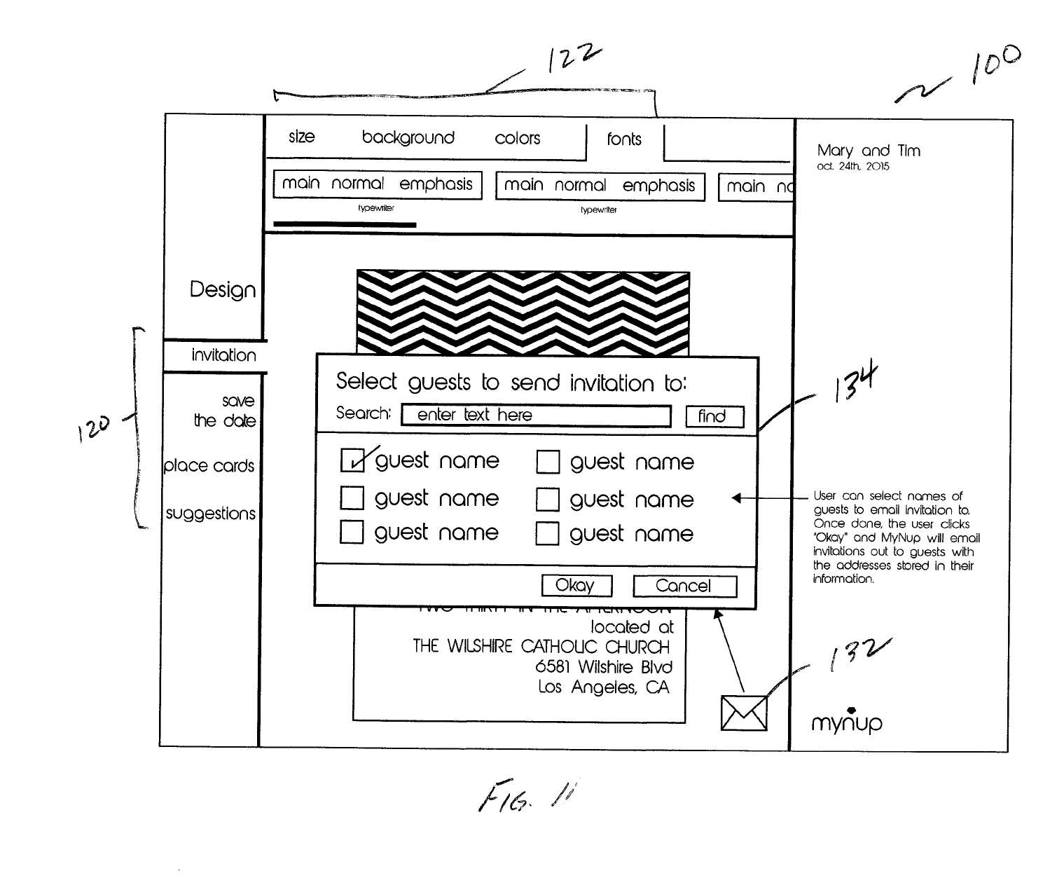

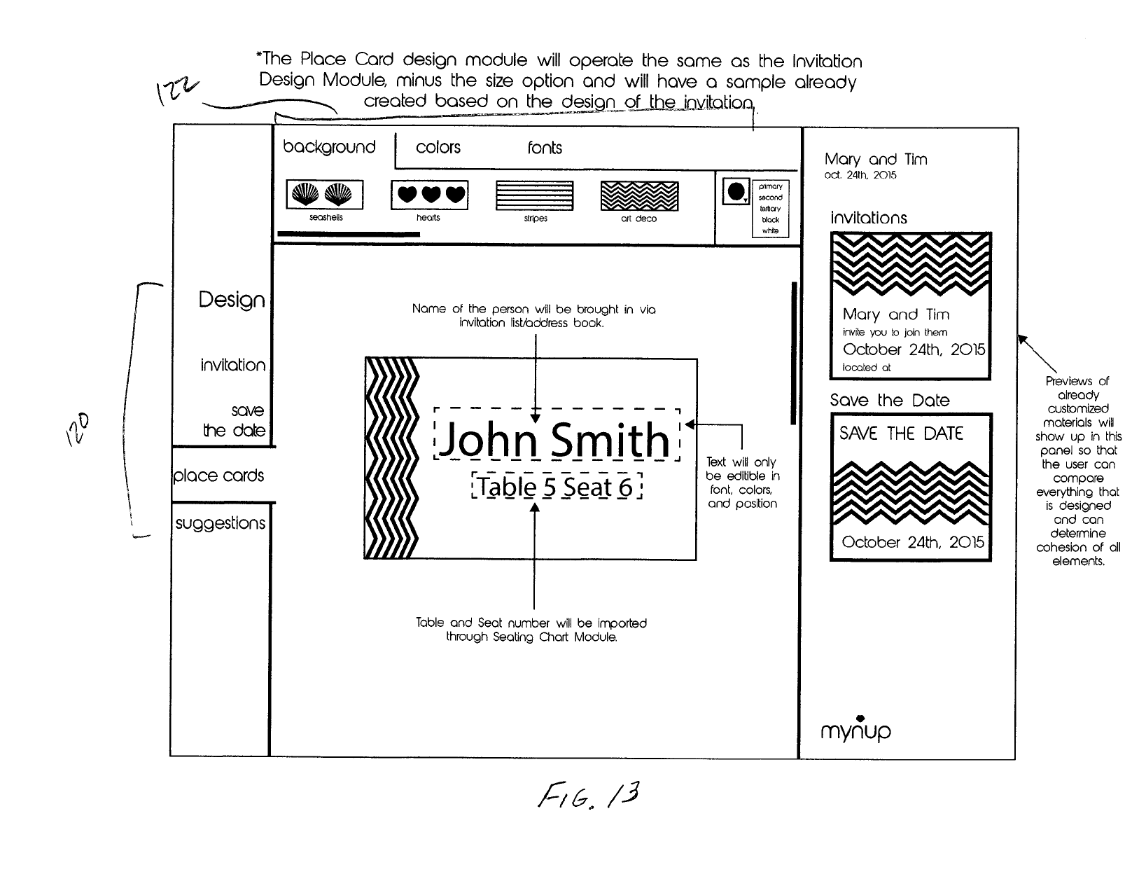

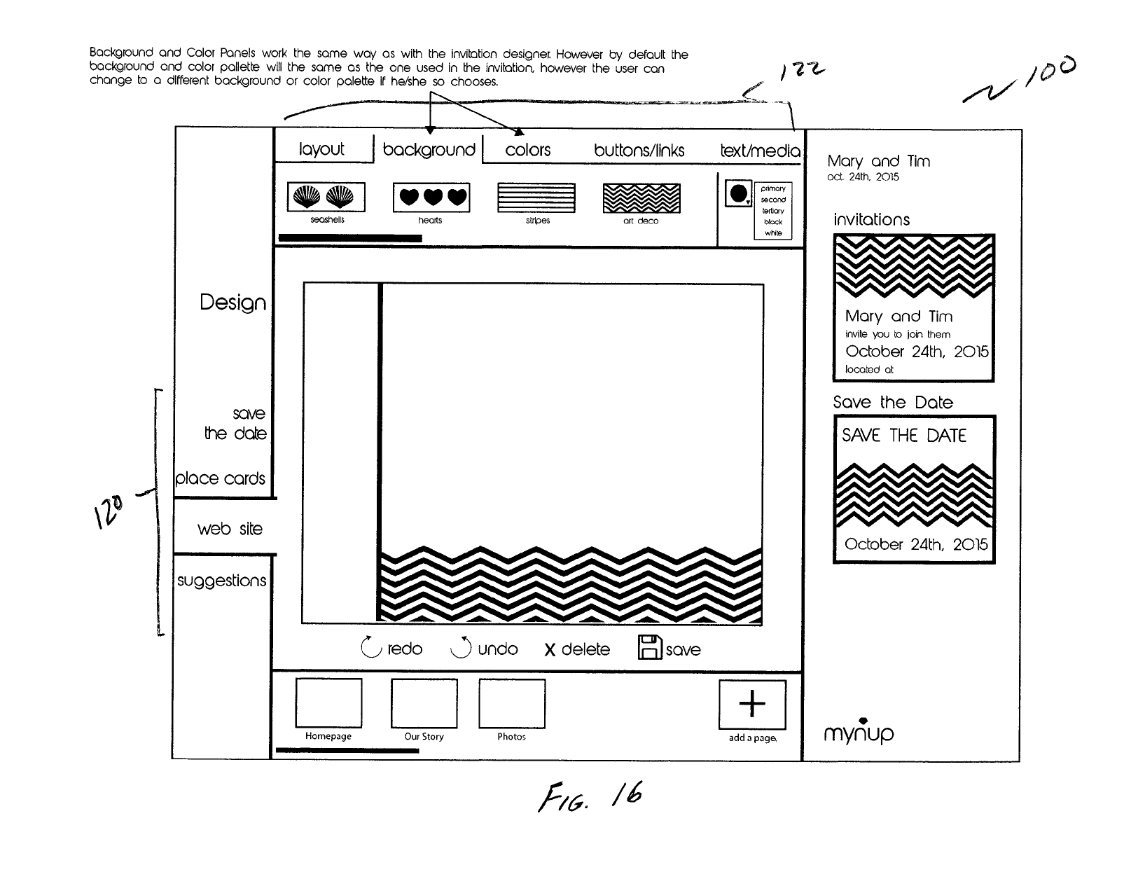

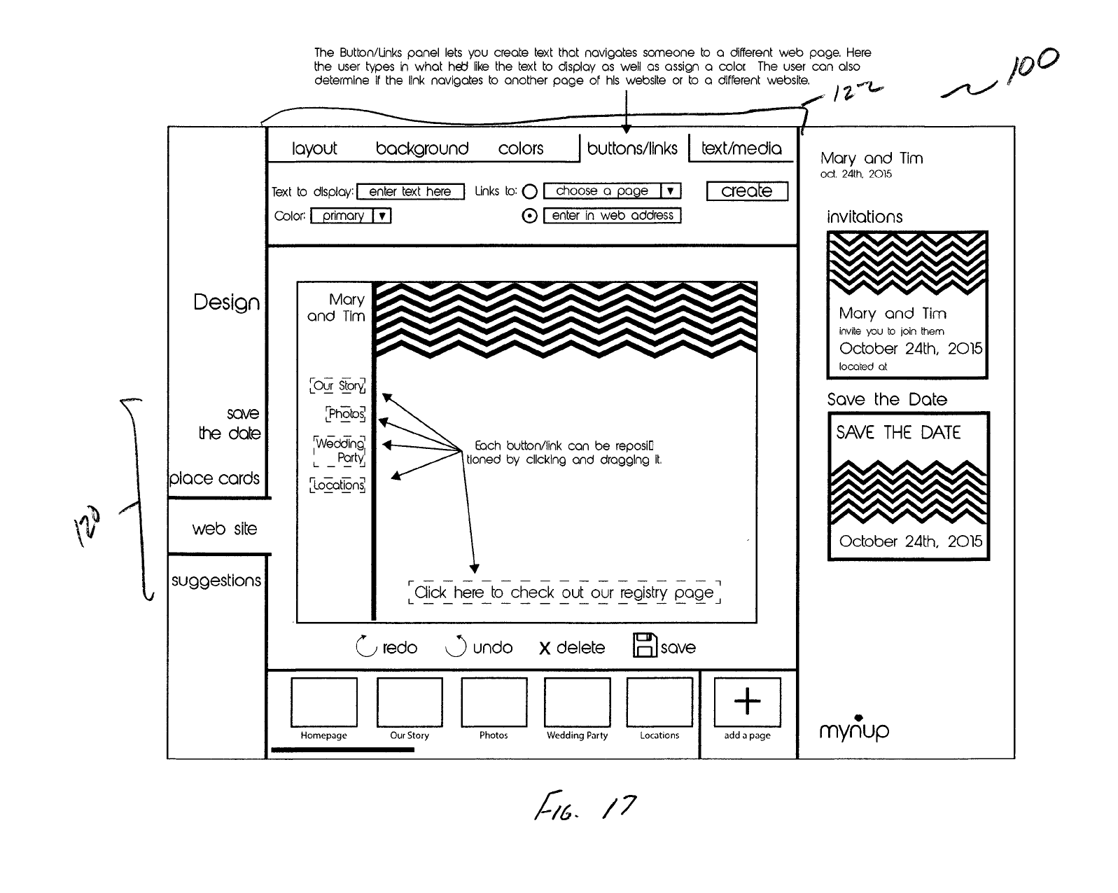

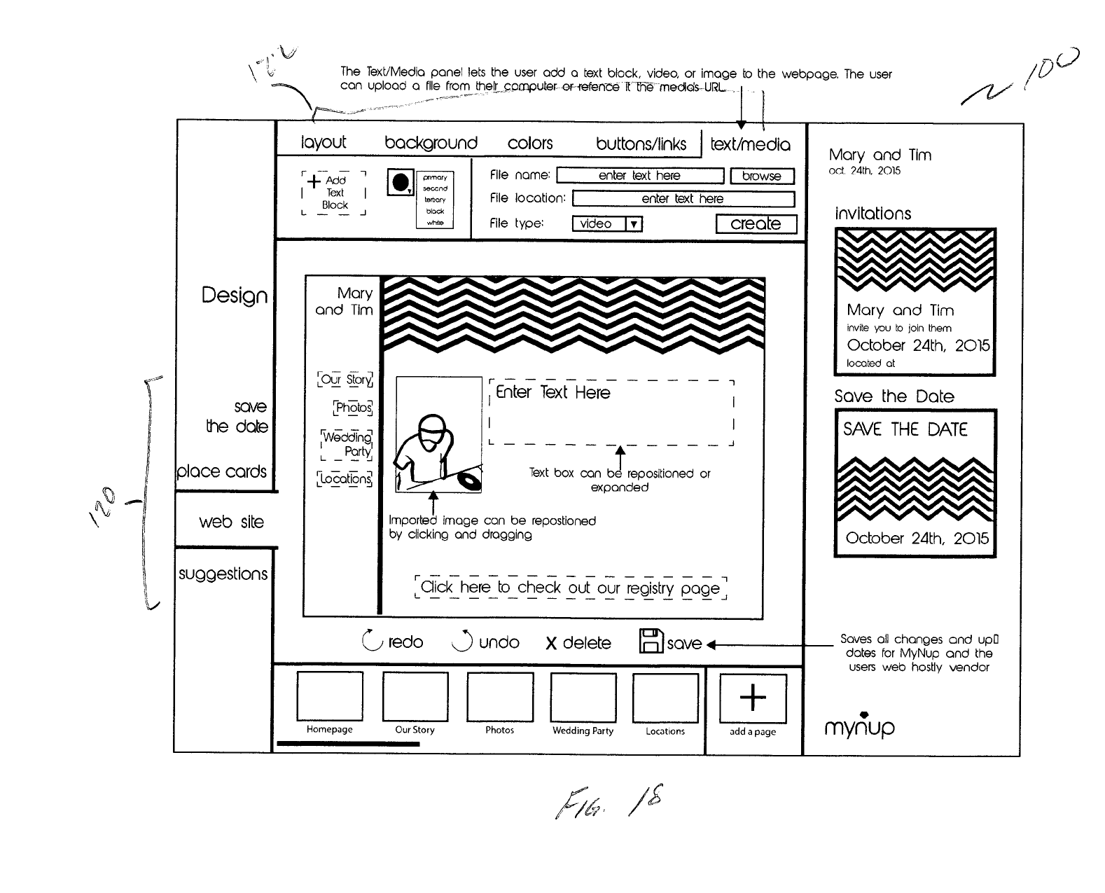

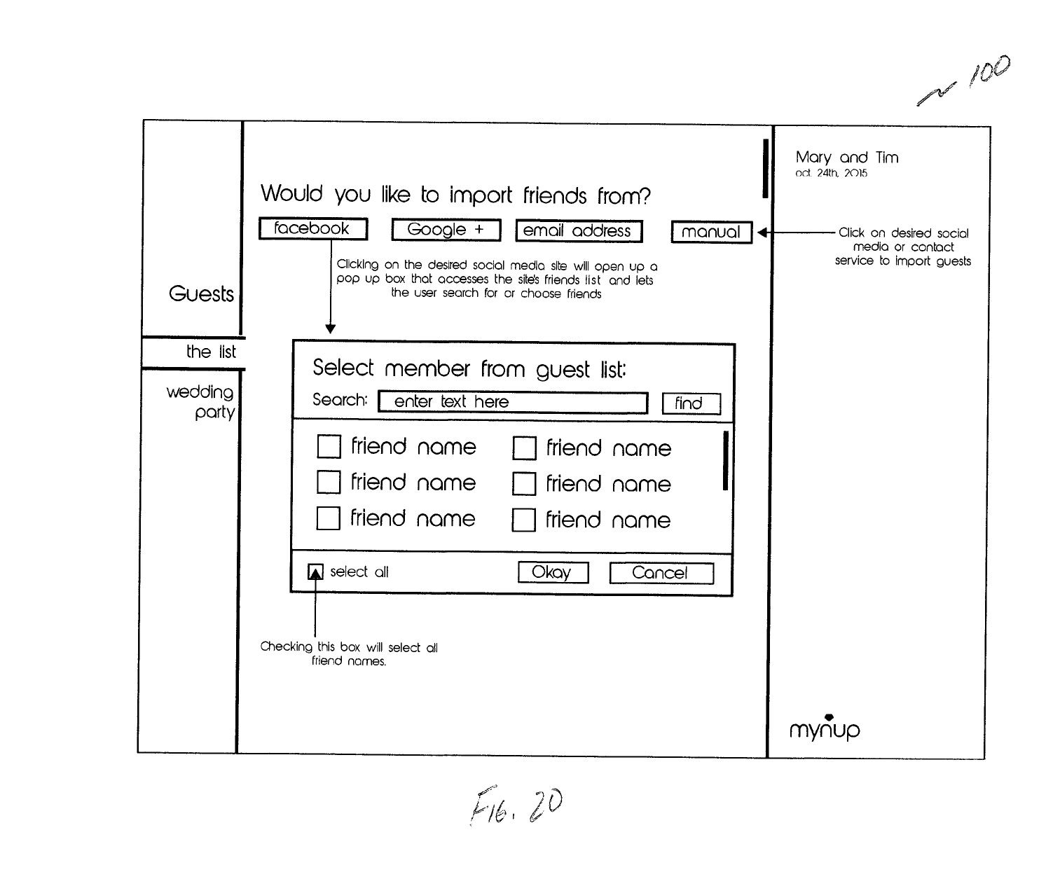

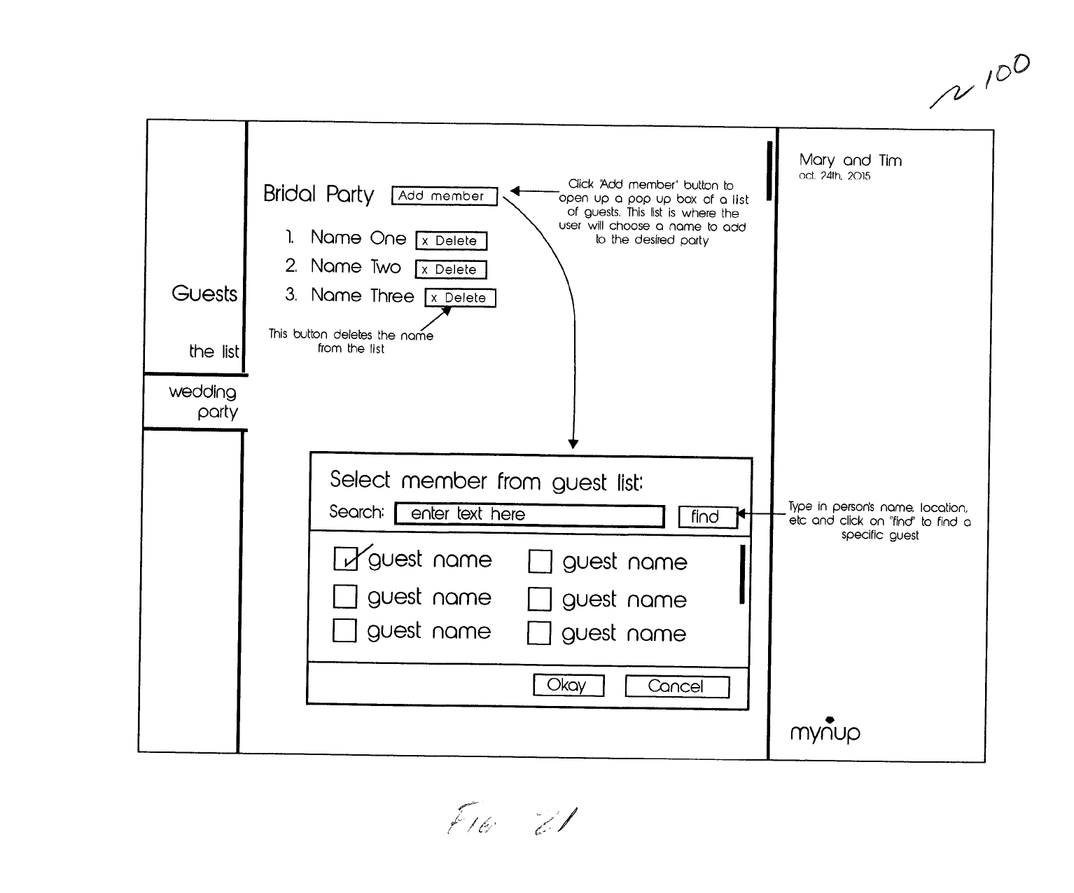

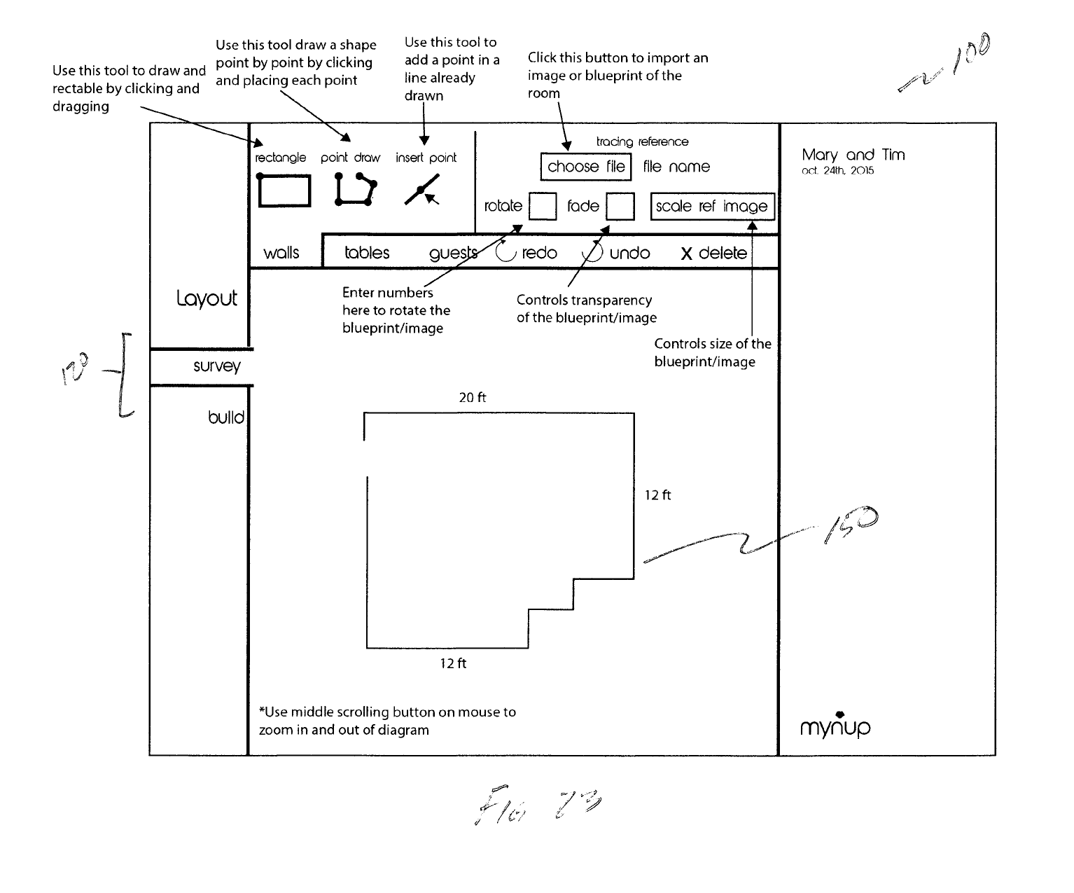

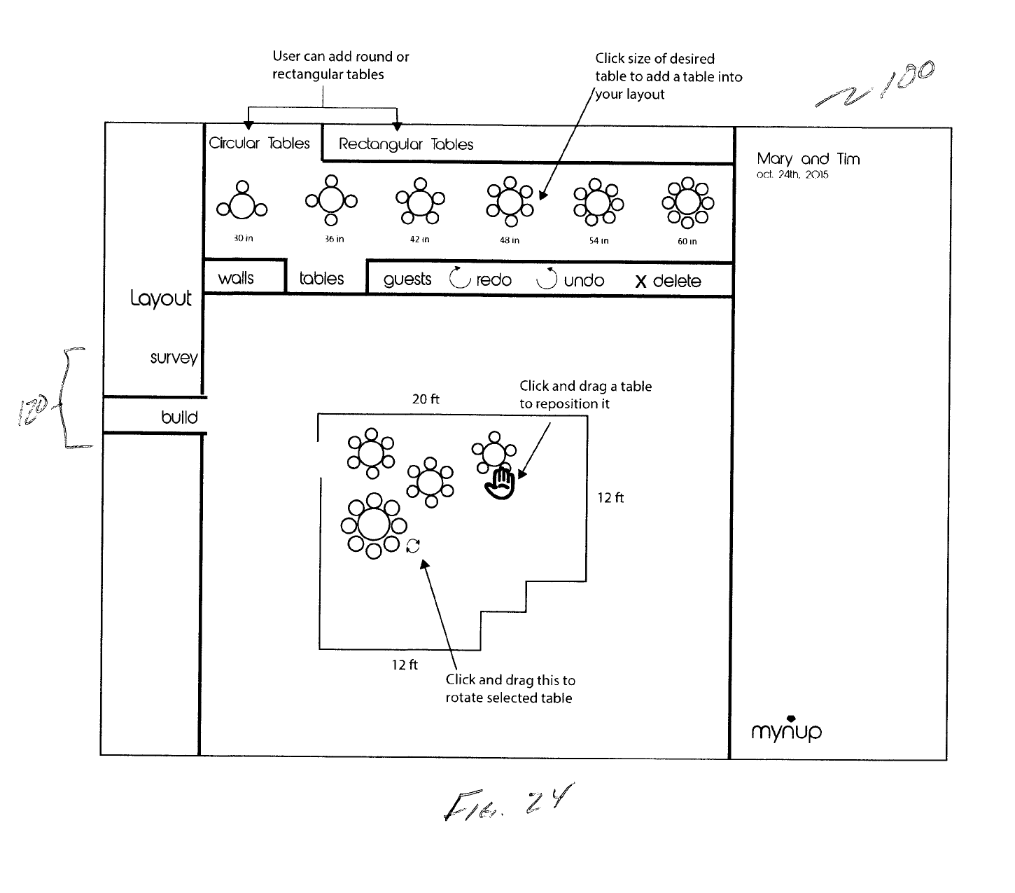

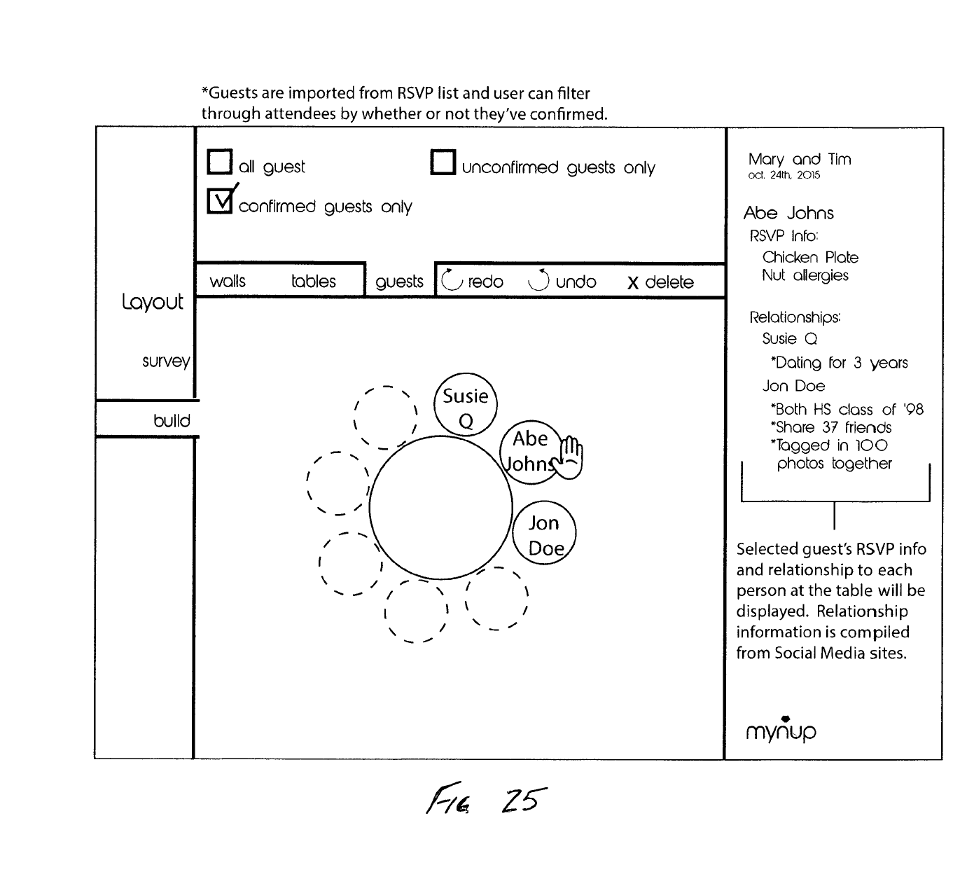

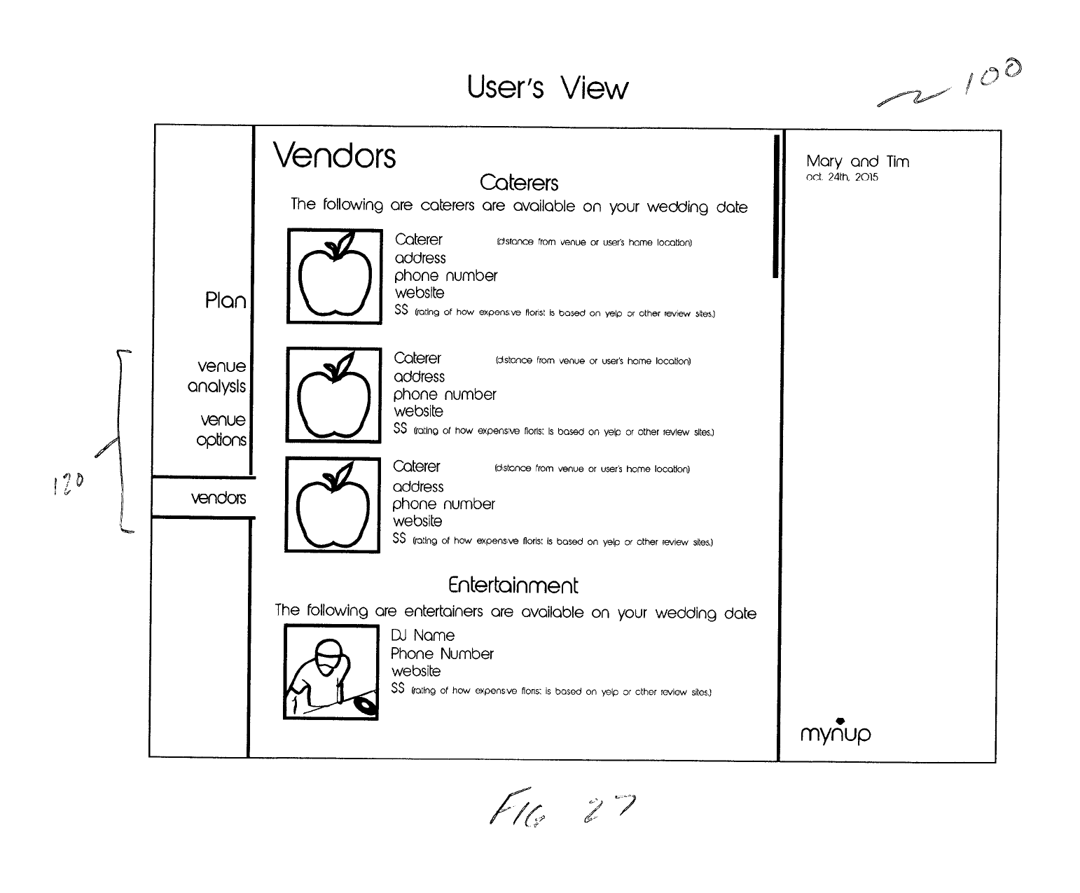

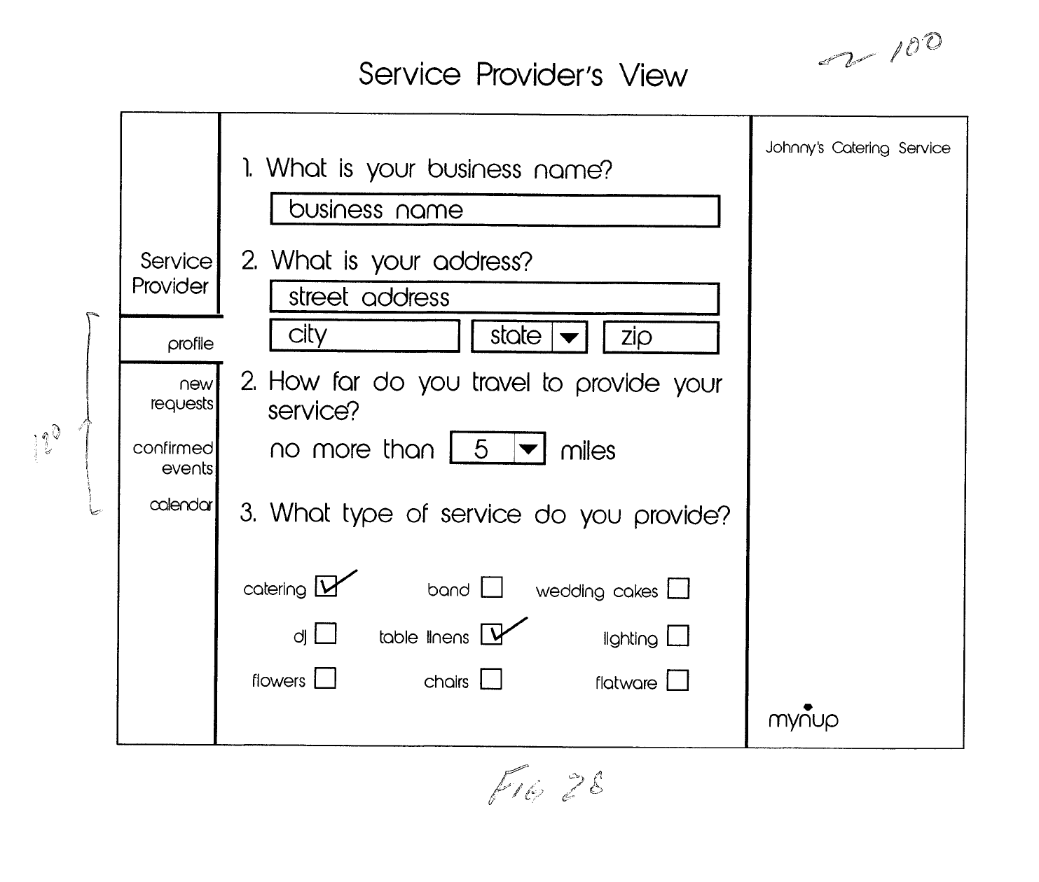

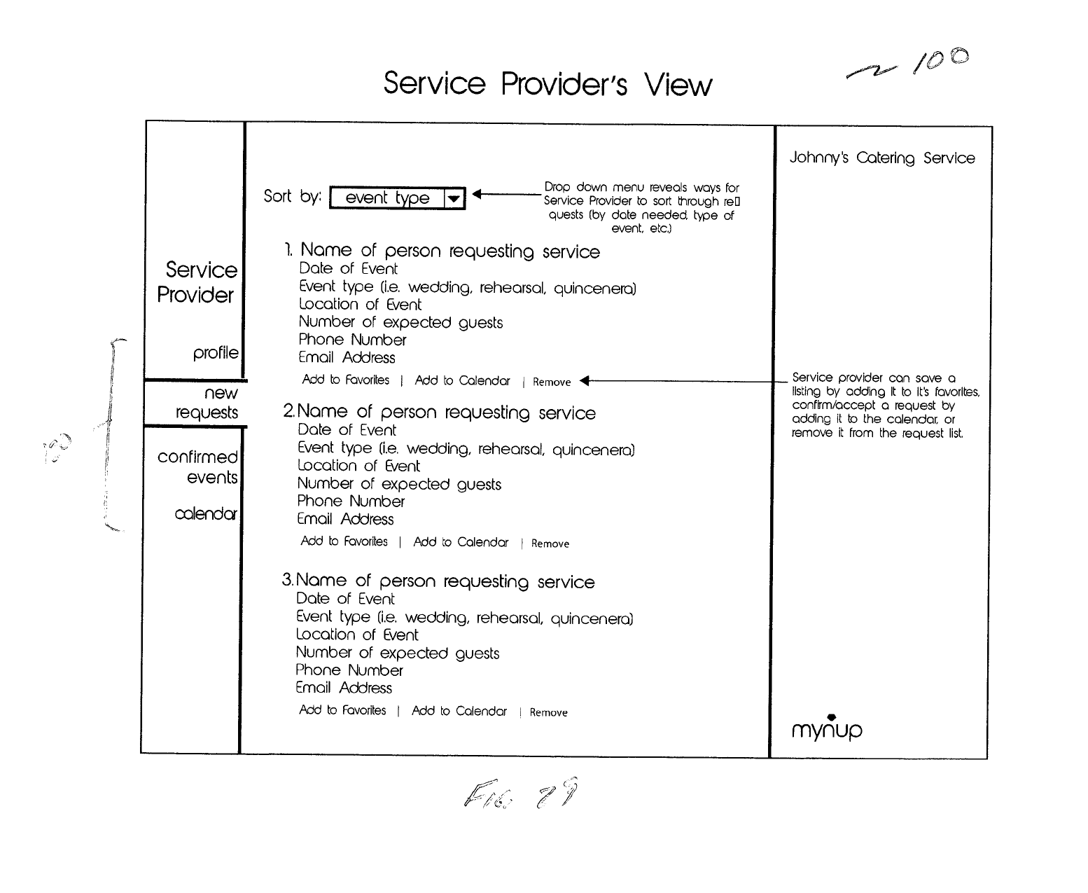

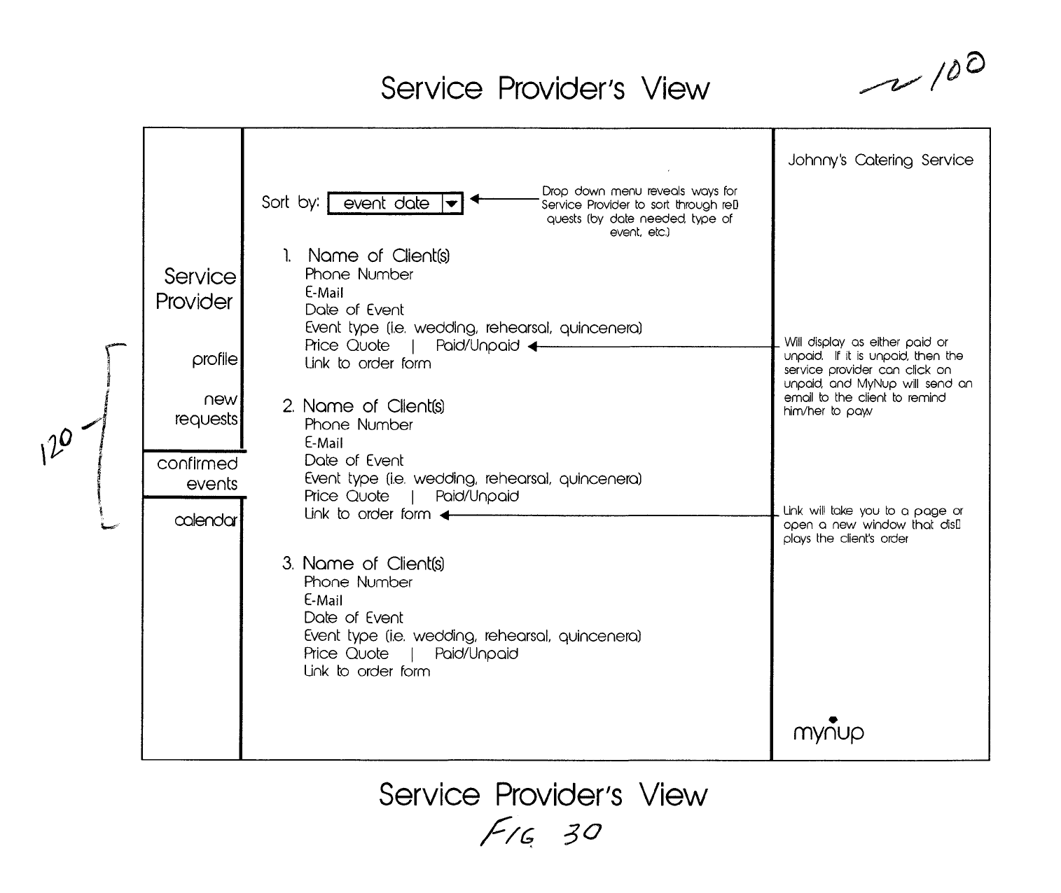

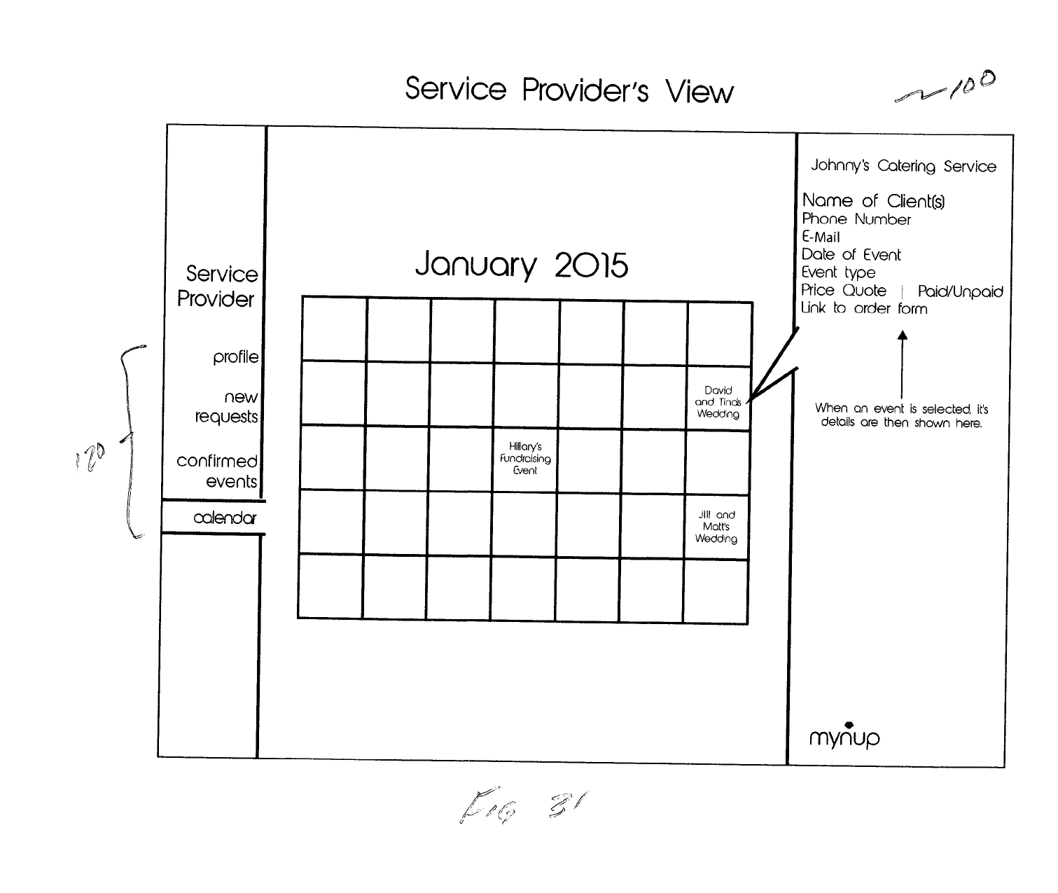

Referring to FIGS. 1-31, various exemplary embodiments of a network based system and method are shown as wire frames of screens presented to a user. Referring specifically to FIGS. 1-5, exemplary opening sign up and interview pages are shown. FIG. 1 shows an exemplary page 100 with icons 102, 104 allowing the user to sign up using various social networks or other systems. FIGS. 2-4 show an exemplary page 100 displaying various elements of an interview module as discussed above. These figures illustrate exemplary elements of an interview module including queries regarding prioritization and atmosphere, as well as providing suggestions and presenting the results of the interview process. In various exemplary embodiments, users can customize the display of the interview module pages, and work through the pages in any sequence they choose. Icons and other indicators on the page provide links to different system features, and provide an interactive graphics based interface allowing users to input information by moving elements 106 on the screen, selecting options from a menu or tabs 108, or inputting text or graphical information directly via dialogue boxes 110 or other features.

### Design Module

Many event planners are not inherently good designers. In various exemplary embodiments, a design module is provided to help event planners develop and maintain design quality and consistency for the event. The design module may allow the user develop a design profile for the event by selecting colors and styles that will be used for the event, including invitations, any event website, decorations, and formalwear. In various embodiments the design module will be integrated with the comprehensive interview module or be presented as a separate module. Through the design module the user selects a color or color palette and invitation design. Based on the user selections, the system may develop and present the user with a customized website, invitation, save the date, and place card design that fit the design profile they created. The color and design information may be used by the service provider module to assist service providers making proposals and expedite shopping for flowers, clothing such as bridesmaid dresses, men's formalwear, etc.

For example, the couple described above planning a wedding may decide on a yellow color palette with a formal design. In various exemplary embodiments, the design module may suggest complimentary colors that the user may accept or reject, then create an editable invitation, website, save the date, and place card design using the selected color palette in a formal design concept. When the user goes to select a florist, local florists with yellow flowers may be displayed, according to price.

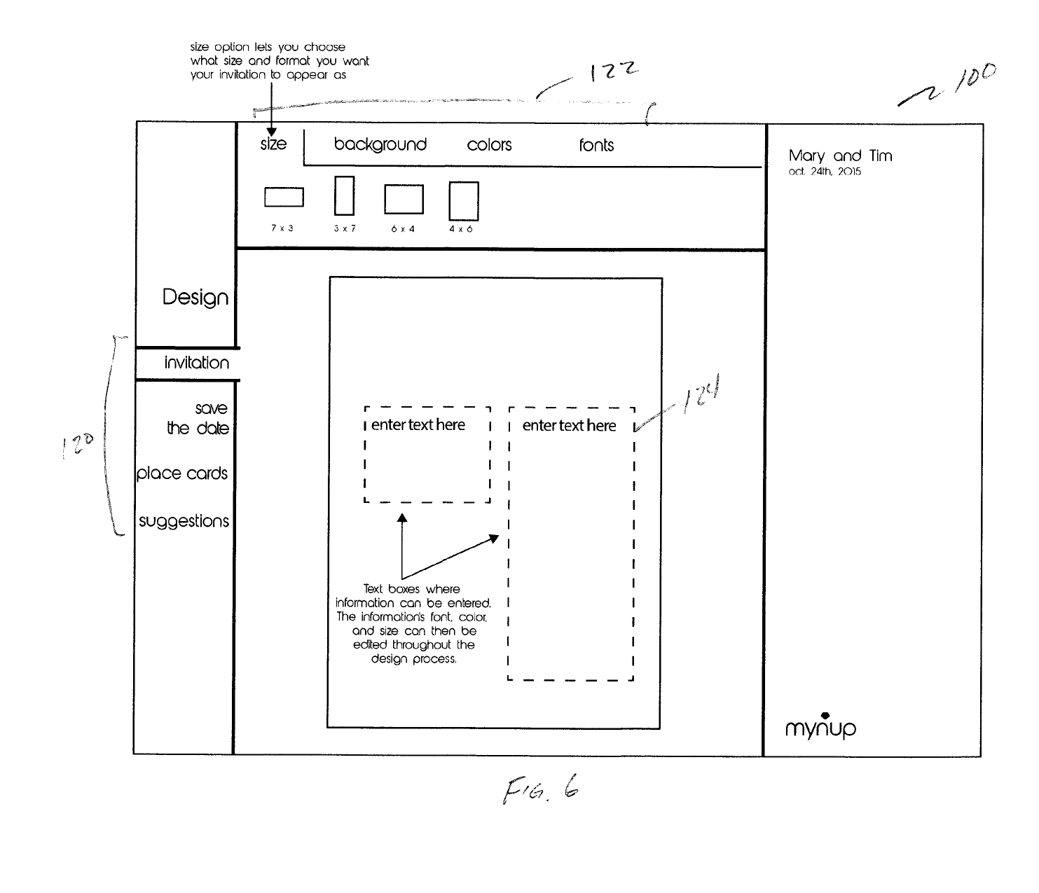

Referring to FIGS. 6-19, exemplary pages presented to the user as part of a design module are illustrated. In various exemplary embodiments, the user can move through various features of the design module using a menu 120. As shown in the figures, such a menu 120 may allow the user to design various items such as invitations, save the date cards, place cards, and receive suggestions from the system for design considerations. A secondary menu 122 may allow the user to make design selections from a variety of design options, such as the size of the item, background design, colors, fonts, etc. For example, a size option may allow the user to choose the size and format of the invitation.

Text boxes 124 or other input options may allow the user to enter text or graphics on the item being designed. Text or graphics entered can then be edited to modify features such as the font, color, and size using the design options provided. In various exemplary embodiments, backgrounds for use on different items can be selected, modified to select colors, positioned, and edited using the various secondary menu options and option-specific editors such as a background color editor 126.

In various exemplary embodiments, a color editor 128 may allow users to sort colors, search by themes such as seasons of the year, or select specific colors for a palette to use in their design. In various exemplary embodiments, a fonts editor 130 may allow users to choose fonts for specific elements, or use font families to maintain an aesthetically cohesive design.

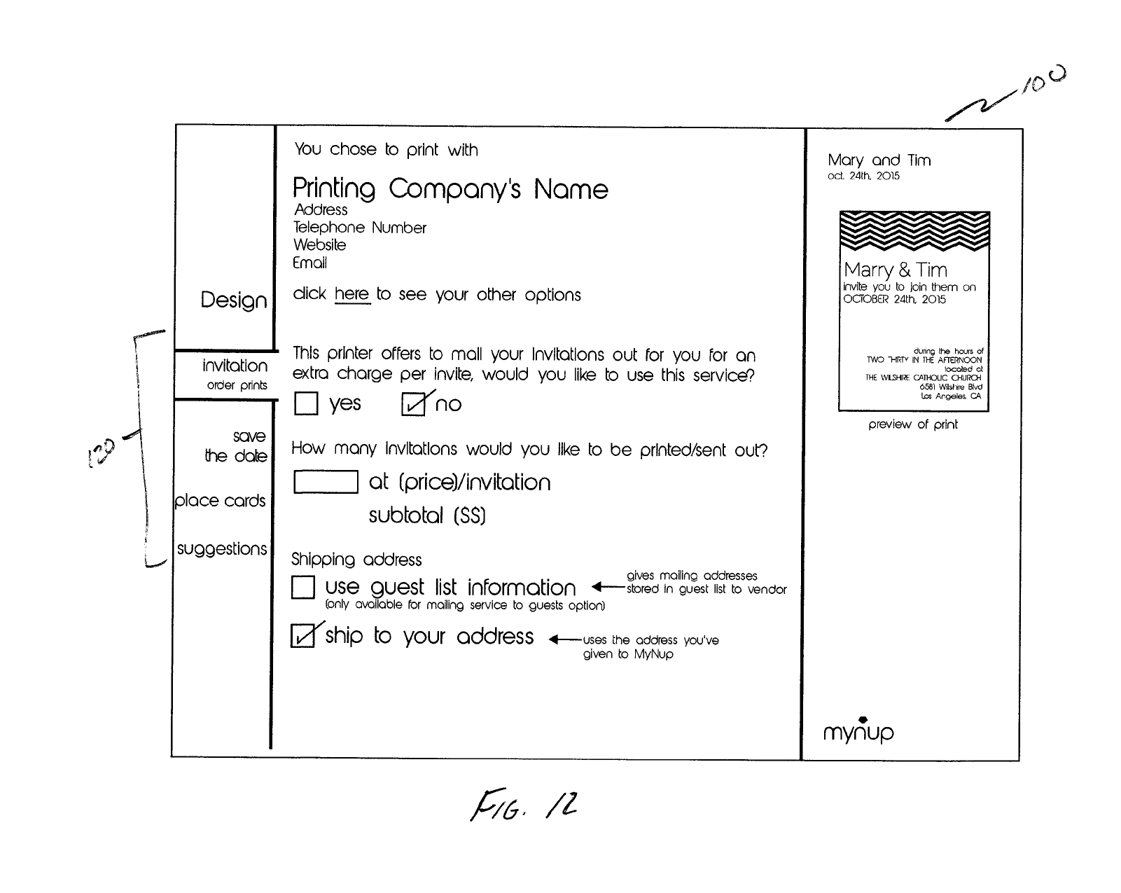

In various exemplary embodiments, the system may display an email or print option button 132 allowing the user can export and send their completed design to a vendor for printing or to create an electronic version for electronic distribution. Such a feature may include a dialogue box 134 that allows the user to input information relevant to the distribution or production of the completed design, such as a list of recipients. As illustrated in FIG. 12, such a feature may further present the user with various options for choosing a printer, and selecting a range of different options for printing and distribution of the completed design, including providing a guest list from the system to the vendor for use in production.

Various items may be designed using information from other features of the system. In various exemplary embodiments, place cards may be designed using information from the guest lists and seating chart module.

Once one item has been designed, the system may use common elements to create templates for other items. For example, once an invitation has been designed, the system may use the same elements such as backgrounds and fonts for a sample place card. In various exemplary embodiments, the system may simultaneously display previews of different items such as invitations, save the date cards, and place cards so that the user can maintain a cohesive design across the different items.

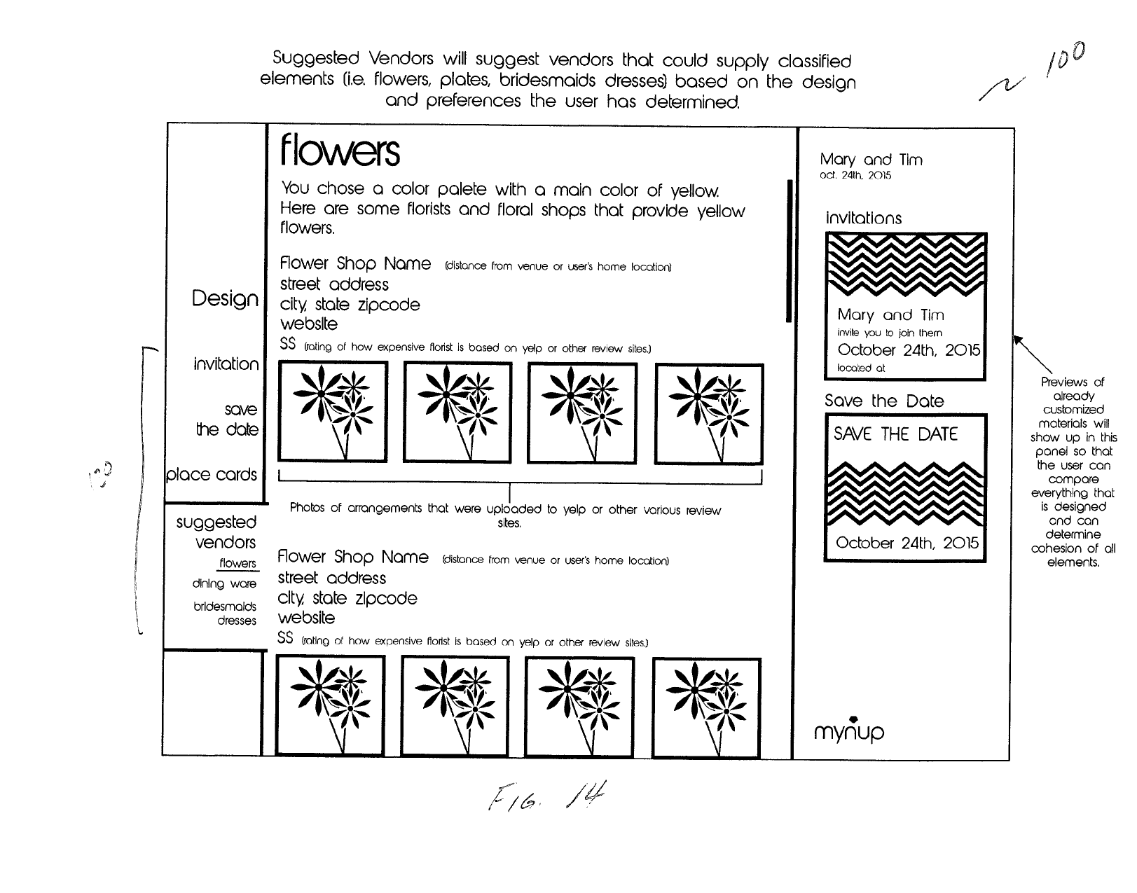

Referring to FIG. 14, the system may suggest vendors that can supply various elements such as flowers, dining ware, bridesmaid dresses, etc. that are consistent with the user's design and based on the user's preferences.

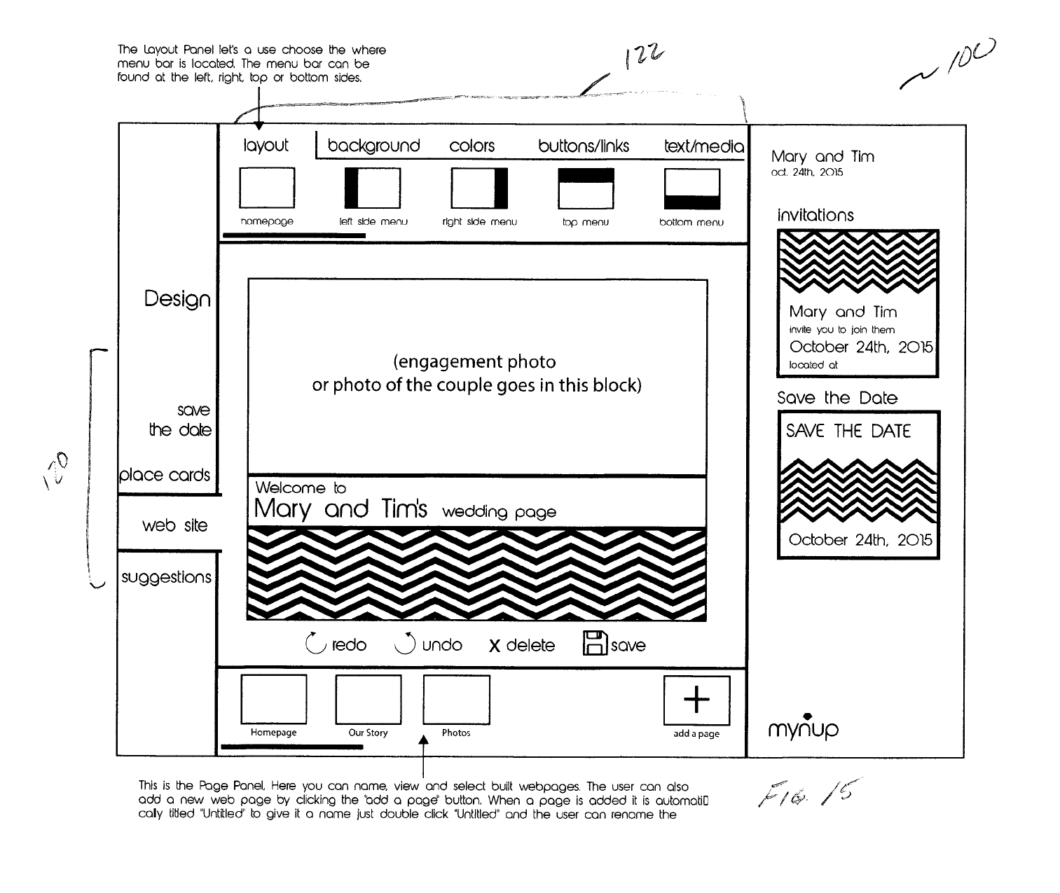

Referring to FIGS. 15-18, in various exemplary embodiments the system may include a web page design feature that allows users to create custom websites for the event. Such a design page may include a layout panel that lets the user select the arrangement of different elements on their screen such as the menu bar, preview panel, etc. In various exemplary embodiments, the system may also include a page panel that allows the user to select, add, name, and view built webpages that will be automatically named. In various exemplary embodiments, the web design page may include controls to set the background and color for the website, or change if from a default matching other designed items such as invitations or save the date cards. In various exemplary embodiments, the system may also include controls that allow the user to create text or other links that allow views to navigate to another web page or web site, and to upload or access text and media including photos and videos for use on the web page.

### Hierarchical Subvendor Analysis Module

In various exemplary embodiments, the method and system may include a hierarchical subvendor analysis module designed to streamline and simplify the process of selecting from among the various options. When planning a large event, many options cannot be determined until a prior selection is made.

For example, many event sites offer onsite food preparation, linens, flatware, chairs, and even specialty event items such as wedding cakes. If the user selects an event site with an “all inclusive” package, the user may proceed directly to selection options from the event site service providers.

However, many event sites do not offer all the services required for a particular event. If the user selects an event site that does not provide catering, the hierarchical subvendor analysis module will recognize this and automatically generate a list of catering service providers that are within the area and match the criteria and preferences selected for the event.

The hierarchical subvendor analysis module analyzes vendor selections, then provides options for other relevant services not provided by the selected vendors, such as chair rental, linen delivery, and flatware, etc., all based on the user's selected criteria. Thus, with each selection, the system will analyze the selected vendor to ensure the vendor provides the services identified by the user in the comprehensive interview. If it does not, the hierarchical subvendor analysis module identifies what services are not offered and generates a list of subvendors matching the users' criteria and preferences.

### Social Media Integration and RSVP Module

Social media sites contain a vast amount of information relevant to planning an event. Social media sites such as FACEBOOK and GOOGLE+ already contain information regarding the event organizer's friends, their friend's relationships, and familial relationship. For simplicity the social media site FACEBOOK will be used to describe social media integration, but it should be understood that any social media site containing personal information of the user and user relationships may be used.

In various exemplary embodiments, the method and system disclosed here may permit users to login with a conventional user account where the user selects a username and password. To access social media for complete integration, the user login and account creation process links to the user's preexisting FACEBOOK account. Users will use their FACEBOOK username and password to request their user account, and the system will then gain access to the user's FACEBOOK account, including all friends names, addresses, and contact information. The social media integration module may then use the information to create a guided prompt for the users to designate FACEBOOK friends as guests or special participants such as speakers, honorees, members of the wedding party, etc. The social media integration module will then generate a provisional guest list and RSVP information based on the user's FACEBOOK information. The user will then be prompted to supplement the invitee/participant list with information not readily available from the FACEBOOK database. In various embodiments, the module will predict invitees+1 and automatically update this information based on updated FACEBOOK information.

In various embodiments of the method and system, a personal Universal Resource Locater (URL) will automatically be generated and sent with the invitations. The invitations may either be sent by e-mail or as traditional postal invitations. Recipients who enter or link to the personal website will be routed to an electronic RSVP manager. Invitees may accept or decline the invitation. Invitees may also designate their food selections or other relevant choices through the RSVP manager.

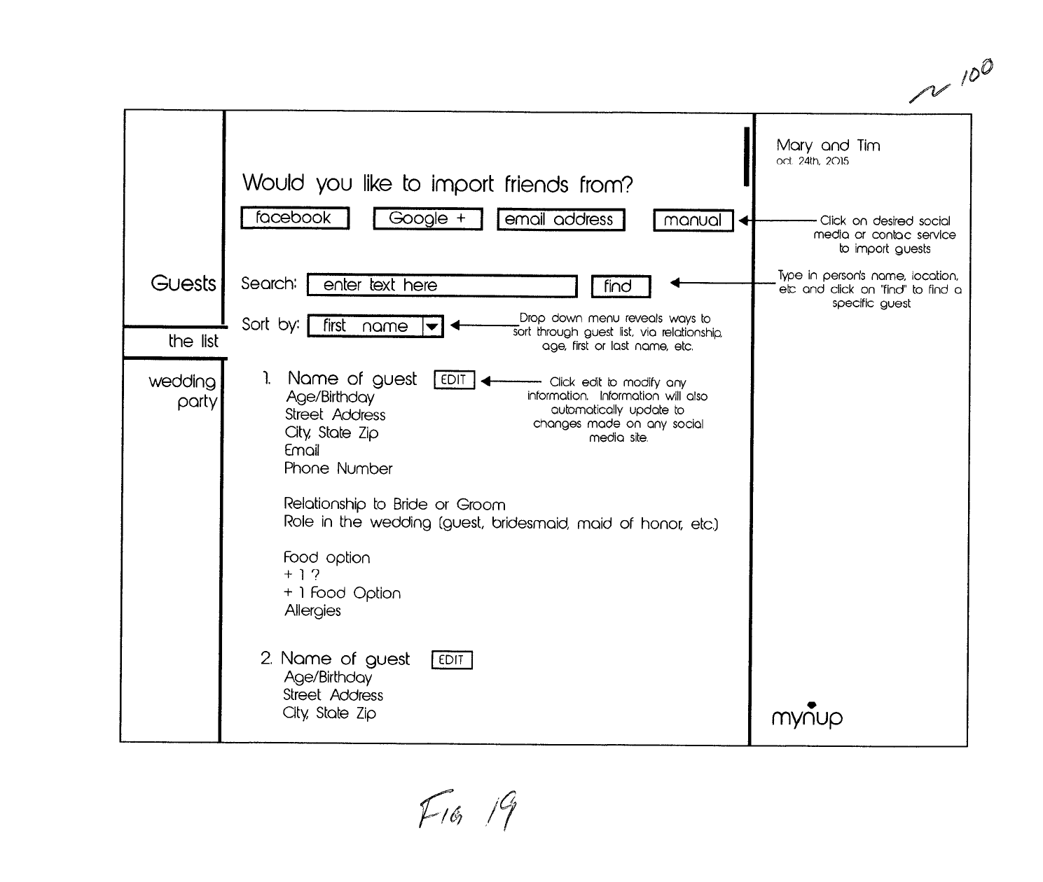

Referring to FIGS. 19-21, in various exemplary embodiments, such information can be used to establish a guest list and query guests regarding choices or preferences for the event. Drop down and other types of menus can be used to sort information and edit the information relating to the guest list. The system can also be configured to allow selection of specific guests by name or other identifying information from contacts on various social media sites or other contact repositories. By selecting a particular social media site or source of contacts, the system may provide the user with a pop-up or other window through which they can select the individual contacts to include on the guest list. Similar features can be provided to establish a list of members of a particular group of guests or organizers, such as members of a wedding party.

### Social Media Integration and Seating Chart Module

In various exemplary embodiments of the method and system, it will mine user information from social media or other resources to eliminate one of the most tedious and frustrating parts of planning social events like weddings, the seating chart. This may be implemented through a seating chart module that analyzes the relationships between the invitees/participants to automatically generate a seating chart based on various parameters that can be controlled by the event organizer In various embodiments, for example, FACEBOOK information will be used to generate a seating chart that includes at least the following functions: couples seated together, families seated together, people with most friends in common seated together, people with a shared high school or college class or year seated together. Analysis of the invitees/participants' self-selected relationship information takes the guesswork out of creating the seating arrangement.

In addition to generating the initial seating chart, the seating chart module may generate a visual representation of the reception area based on user input regarding the number and type of tables and the number of guests per table. Through a user interface, users will be able to simply rearrange the seating designation of a guest by clicking on the guest icon and dragging it to a different location. Seating charts may also be automatically re-generated based on manual change or they may operate in a ‘locked’ mode where the user manually makes all adjustments to seating.

### Layout Module

In various exemplary embodiments of the method and system, a layout module will present event organizers with a series of questions regarding the spatial layout of the wedding reception venue. The user may enter the room dimensions, number, size, and shape of tables, place settings per table, and server/entertainment areas. An editable visual representation of the event space can then be generated from this information, and the user may rearrange the tables and service/entertainment areas of the room to their desired specifications.

In various exemplary embodiments, the user will be presented with a large variety of options to further populate the visual representation of the event space. These options may include table linens and color options, flowers, place settings, favors, signs/banners, people, lighting, windows, doors, curtains, dance floor space, the DJ booth, etc., to provide a comprehensive visual representation of the event space that may be sent to service providers or exported to PDF to provide anyone with a complete view of the event space and layout. The layout module may be integrated with the seating chart module and RSVP modules to populate the room with guest names, food preferences, etc.

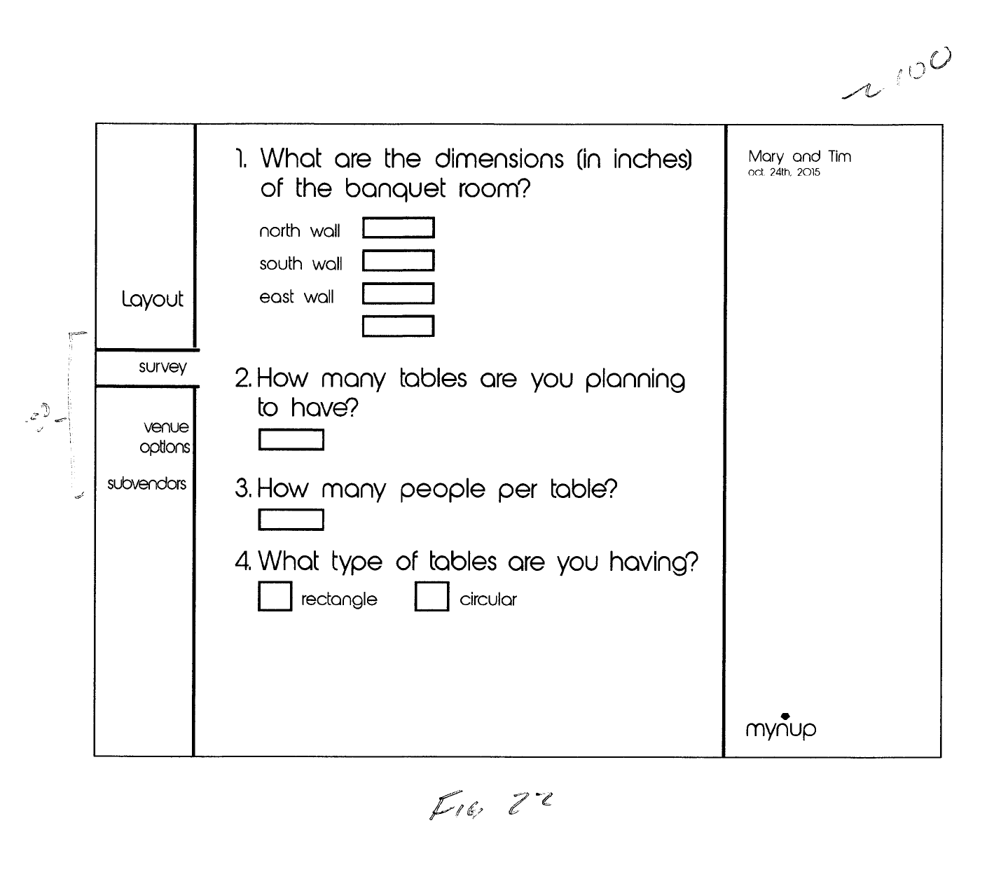

Referring to FIGS. 22-25, in various exemplary embodiments the system may provide survey questions to the user to establish information for use in developing the layout for their event and setting their seating arrangements. The layout module may also include a graphical planning tool that allows users to create a graphical representation of the event space 150 then place elements such as tables within that space and adjust their location and orientation. A wide range of tools may also be provided to allow the user to click, drag, and drop different elements, draw custom shapes, add points to elements, import information such as room dimensions, layout, etc., modify the view of elements to rotate, change transparency, or change size or other features. Specific tools for common elements such as tables and chairs may be provided along with an interface to allow various options relating to such elements to be selected.

In various exemplary embodiments, the user can import guest information from the guest list, RSVP list, or other source and filter guests for status or other characteristics including relationships. Relationship information compiled or imported from social media sites can also be displayed to the user for use in setting up seating charts.

### Wedding Service Provider Module

In various exemplary embodiments of the method and system, a service provider module will also be provided. The service provider module may present service providers with a guided interview to identify the services and options offered by the service provider for potential customers. The service provider may be able to offer and accept reservations, deposits, and payments through the system, and can use information from a users account to provide critical information to the service provider.

For example, if the service provider is a caterer, information from the RSVP module can be used to provide the caterer with information on food selections, preferences, and allergy information in real time. The seating chart module will provide a comprehensive guide to the caterer when it comes time to serve the food. In various embodiments, e-mail reminders may be sent to the service provider for securing deposits, check-ins, and contract dates. A service provider calendar will ensure that users only see service providers that are available for the selected dates and that the service provider is not bothered with requests for booked dates.

In various exemplary embodiments, a service provider application or platform may be provided. Service providers may create simple, searchable customer facing sites to help sell products and provide organizational capabilities. A custom website can be generated for a service provider based on a comprehensive interview of the service provider. Service providers may also generate and manage promotional offers available to event planners, individual selectable options or packages, and vendor information. The service provider application may provide information regarding important dates, such as deposit due dates, generate invoices, and track paid invoices. A method and system may also be provided that allows service providers to directly receive specific event information such as orders for particular dishes, guest allergy information, dietary restrictions, etc.

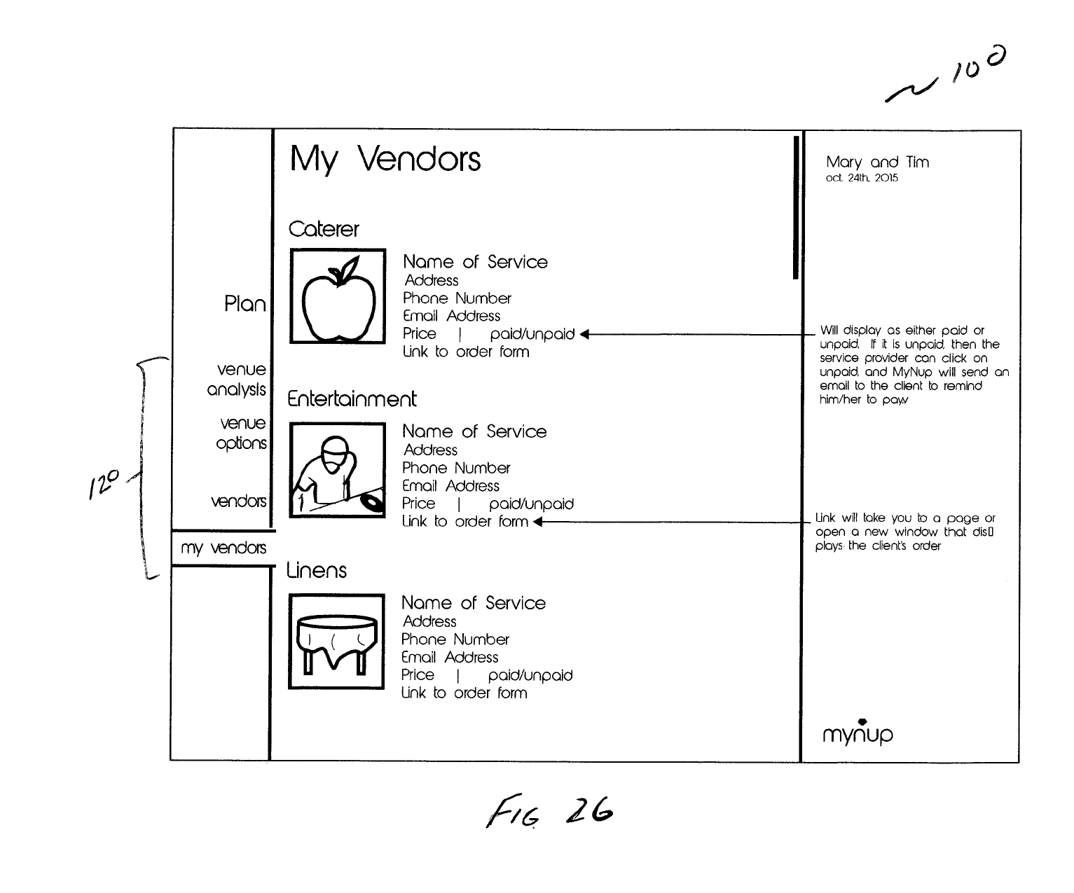

Referring to FIGS. 26-31, in various exemplary embodiments the system can display a wide range of vendor information to users for use in selecting vendors, as well as provide a platform for users to maintain vendor information and for vendors to access and exchange information with users. Vendors and users may be provided with different page displays appropriate to their respective access to different features. Vendors may be provided with entry pages for them to provide information relating to their listings on the system, and with pages having tools for them to calendar, confirm, and manage their commitments including payment for services. The system can facilitate communications between vendors and users by providing messaging in response to inputs. For example, a vendor that has not been paid may be able to click on a link and the system will generate and send a payment reminder. Links may also be provided to other documents or information relevant to a vendor or user.

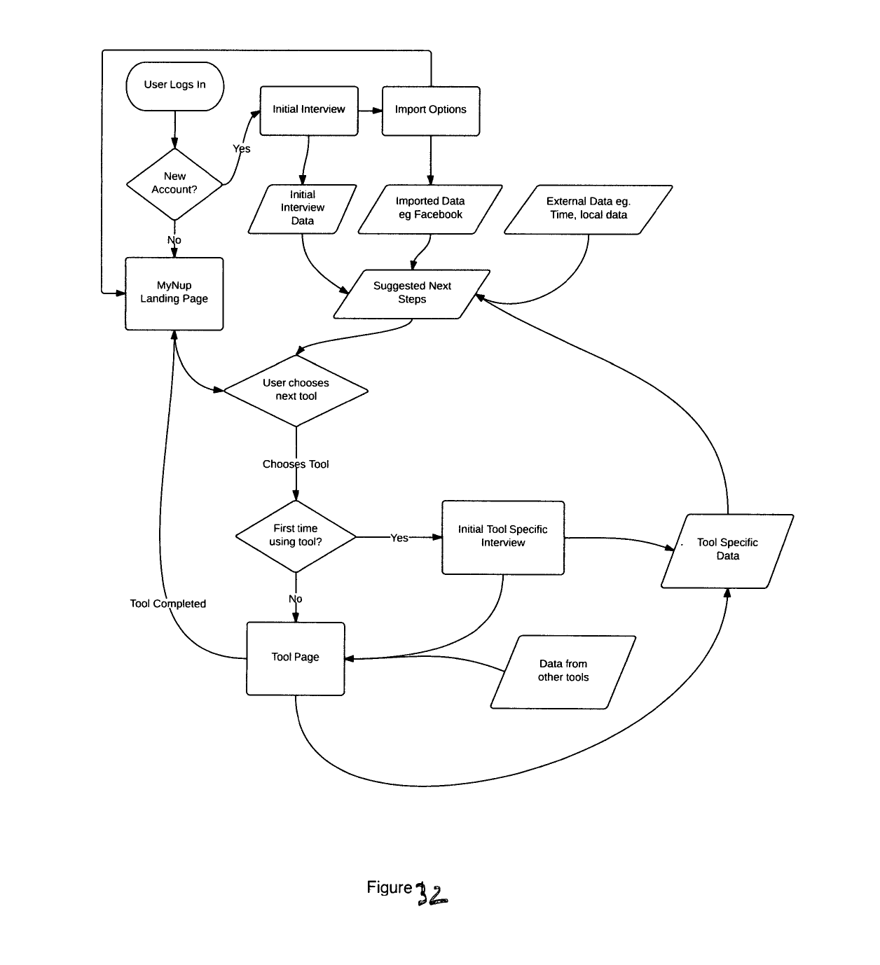

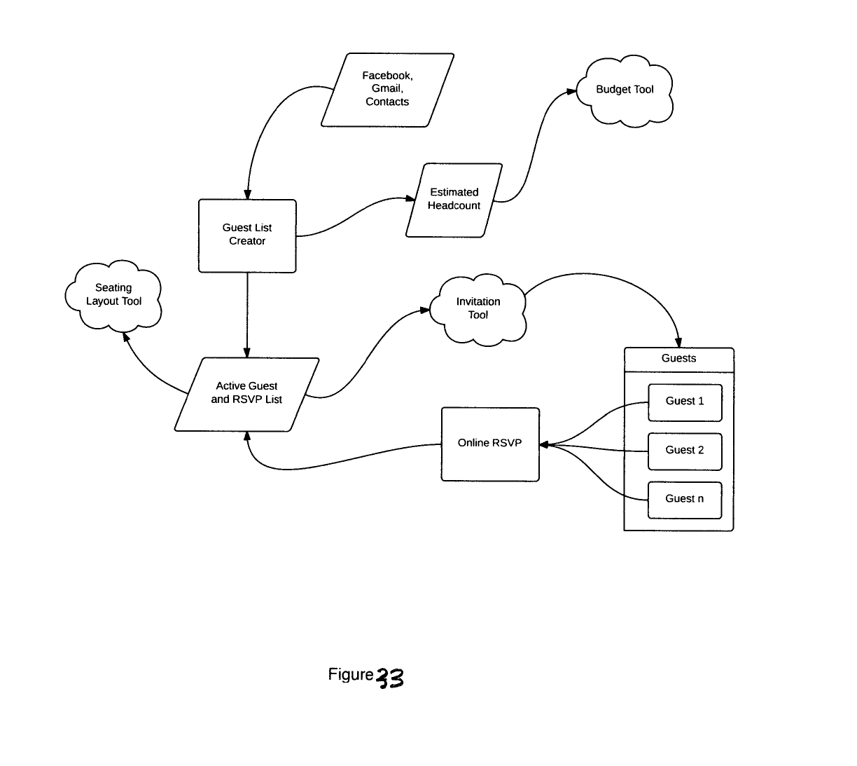

The accompanying FIGS. 32 and 33 show exemplary embodiments of the method of practicing the present invention. FIG. 32 shows the steps comprising an exemplary embodiment of the invention from user login through collection of interview data, importation of social media and other data, through the use of the various planning tools provided by the system. FIG. 33 shows the steps comprising an exemplary embodiment of a social media and seating chart module from importation of social media and contact data to create a guest list, headcount and budgeting tools, invitation and RSVP return tools to notify invitees and facilitate their responses, and a seating layout tool.

The method and system described herein can be deployed on any suitable network accessible by an event planner. The system will generally include a network that may be the internet, an intranet, or any other suitable system accessible by multiple users via software on a computing device such as a browser or other application program. The system may communicate with various types of computing devices over network including any type of digital computing device, such as a tablet, mobile computer, smart phone, desktop computer, or mainframe.

In various exemplary embodiments, the system includes a server or servers configured to provide online services by exchanging binary data, XML data, HTML, or other markup language to client computing devices via the network. The system can access information from any available networked source including email and online social networks of all types, as well as public and private information networks and databases.

Any suitable computing devices can be used for the system and for the clients. Typical computing devices may include a processor, database, and one or more input and/or output (I/O) devices that are communicatively coupled via a local interface. The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

Input device(s) may include devices such as a touch pad, keyboard, mouse, pen, voice input device, gesture detection device, or any other suitable input device. Computing devices may also include one or more devices or be connectable to such output devices, including various types of displays, speakers, glasses, printers or other devices. Such computing devices may include communications components to allow the computer device to communicate with other computing devices, including wired network or direct-wired connections, and wireless media such as acoustic, radio frequency, infrared, and other wireless media.

In various exemplary embodiments, such computing devices typically include at least one processing unit to execute instructions and volatile or non-volatile memory or storage to manage and store information including executable code such as operating systems and application programs. The computing devices can also have a wide range of additional features and functionality. The processing unit may be a hardware device for executing software, and may be any custom made or commercially available processor, a central processing unit (CPU), an auxiliary processor among several processors associated with the computing device, a semiconductor based microprocessor (in the form of a microchip or chip set), a macroprocessor, or generally any device for executing software instructions.

The computer can include software applications that can be stored on any computer readable medium for use by or in connection with any computer related system or method. The various exemplary embodiments of the invention computer readable instructions are executed by one or more computing devices. Computer readable instructions may be distributed via computer readable media or via any suitable network, and may be implemented as program modules or other suitable program structures that perform various computing tasks. Various types of computer readable media may be used, including including volatile and nonvolatile, removable and non-removable media for storage of information such as computer readable instructions, data structures, program modules, or other data. Examples of computer readable storage media include RAM, ROM, EEPROM, flash memory or other memory technology, removable media such as CDs and DVDs, or any other type of optical, magnetic, or other storage device.

The system may include one or more database, which can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the database may incorporate electronic, magnetic, optical, and/or other types of storage media. Note that the database can have a distributed architecture, where various components are situated remote from one another, but can be accessed by the processor. For example, the database may have a partitioned drive for storage of data in separate and distinct areas with communication therebetween through the processor.

All of the systems described herein may be distributed across a network, such as in cloud-based computing systems.

What is claimed is:

1. A system for providing users with wedding planning tools via a network, comprising:
one or more servers for executing an application that provides code to a user's client computer for display on the user's client computer of various web pages for planning an event,
the web pages comprising a signup page configured to allow the user to sign up to gain access to the system,
a plurality of design pages configured to allow the user to design a plurality of different items relating to the event including at least an invitation to the event;
a plurality of layout pages configured to allow the user to plan the arrangement of tables at the event and assign seating for a plurality of guests that are anticipated to attend the event,
wherein information regarding the plurality of guests is obtained in part from a social network selected by the user.

2. The system of claim 1, wherein the network is the internet.

3. The system of claim 1, wherein the layout pages are configured to allow the user to drag and drop tables on a graphical representation of a location where the event will be held.
